(19) United States
(12) Patent Application Publication
(10) Pub. No.: US 2019/0171081 A1
(43) Pub. Date: Jun. 6, 2019

(54) CONTROL METHODS FOR TINTABLE WINDOWS IMPLEMENTING INTERMEDIATE TINT STATES

(71) Applicant: View, Inc., Milpitas, CA (US)

(72) Inventors: Jason David Zedlitz, Rancho Cordova, CA (US); Pradeep Gaddam, Santa Clara, CA (US); Guy Ganani, San Jose, CA (US)

(73) Assignee: View, Inc., Milpitas, CA (US)

(21) Appl. No.: 16/303,384

(22) PCT Filed: May 31, 2017
(86) PCT No.: PCT/US17/35290

§ 371 Date: Nov. 20, 2018

Related U.S. Application Data
(60) Provisional application No. 62/343,650, filed on May 31, 2016.

(51) Int. Cl. G02F 1/163; E06B 9/24; G02F 1/155

(52) U.S. Cl. CPC G02F 1/163; G02F 1/155; E06B 9/24

(57) ABSTRACT

A method of controlling tint of a tintable window in a building is provided. The method comprises defining one or more threshold values of environmental conditions across a defined time period, defining two or more discrete tint state values for the tintable window, and if the input readings during the defined time period cross one or two of the one or more threshold values, sending a tint command to transition the tintable window from a first tint state toward a second tint state and not transitioning further during a lockout period.

### CROSS-REFERENCE TO RELATED APPLICATION

This application claims benefit of and priority to U.S. Provisional Patent Application No. 62/343,650 entitled “CONTROL METHODS FOR TINTABLE WINDOWS IMPLEMENTING INTERMEDIATE TINT STATES” and filed on May 31, 2016, which is hereby incorporated by reference in its entirety.

### FIELD

The embodiments disclosed herein relate generally to window controllers and control logic for implementing methods of controlling tint and other functions of tintable windows (e.g., electrochromic windows).

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance. One well-known electrochromic material is tungsten oxide (WO₃). Tungsten oxide is a cathodic electrochromic material in which a coloration transition, transparent to blue, occurs by electrochemical reduction.

Electrochromic materials may be incorporated into, for example, windows for home, commercial and other uses. The color, transmittance, absorbance, and/or reflectance of such windows may be changed by inducing a change in the electrochromic material, that is, electrochromic windows are windows that can be darkened or lightened electronically. A small voltage applied to an electrochromic device of the window will cause them to darken; reversing the voltage causes them to lighten. This capability allows control of the amount of light that passes through the windows, and presents an opportunity for electrochromic windows to be used as energy-saving devices.

While electrochromism was discovered in the 1960s, electrochromic devices, and particularly electrochromic windows, still unfortunately suffer various problems and have not begun to realize their full commercial potential despite many recent advances in electrochromic technology, apparatus and related methods of making and/or using electrochromic devices.

### SUMMARY

Systems, methods, and apparatus for controlling transitions of electrochromic windows and other tintable windows to different tint levels are provided. Generally, embodiments include control logic for implementing methods of controlling tint levels of one or more electrochromic windows or other tintable windows. Typically, the control logic can be used in a building or other architecture having one or more electrochromic windows located between the interior and exterior of the building. The windows may have different configurations. For example, some may be vertical windows in offices or lobbies and others may be skylights in hallways. More particularly, disclosed embodiments include control logic that provides a method of determining and changing the tint level of one or more tintable windows to directly account for occupant comfort.

Occupant comfort involves making tinting decisions that reduce direct glare and/or total radiant energy directed onto an occupant or their area of activity while allowing sufficient natural lighting onto the area. Occupant comfort also involves making tinting decisions that are aesthetically pleasing to an occupant, for example, by taking advantage of intermediate tint states and wait times to damper the reactiveness of control methods to temporal changes in radiation fluctuations from, e.g., intermittent clouds. The control logic may also make use of considerations for energy conservation.

The control logic described takes advantage of fast switching to intermediate tint states and the ability to start a new transition before completing the previous transition for more smoothly adapt to an assessment of known conditions. Generally speaking, the described control logic is used to implement methods that control tint transitions in an electrochromic window or other tintable window to account for occupant comfort and/or energy conservation considerations. These methods typically determine a regime, make tint decisions based on statistically probable conditions, and then send tint commands for controlling transitions in the tintable window.

In certain embodiments, the control methods make tint decisions by using photosensor readings and optionally other input to see whether a tint transition is suggested. For example, high solar irradiance readings above an upper threshold may indicate that it is clear sky and sunny. Even if the method suggests a transition of more than two tint regions, a tint command is sent to transition the window only a single tint region. If the ending tint region was dictated by control logic that relies on current outside conditions (e.g., clear sky and sunny, intermittent clouds, etc.), then the method locks out further transitions for a lockout period. During the lockout period, the control method monitors input about outside conditions and statistically assesses what occurred (known historical data) during the wait time. Once exiting the lockout period, the method determines the current regime and a suggested tint region based on a statistical assessment of the conditions monitored during the lockout period.

Certain implementations are directed to methods of controlling tint of a tintable window in a building. In various aspects, the methods comprise defining one or more threshold values of environmental conditions across a defined time period, defining two or more discrete tint state values for the tintable window, receiving input readings of actual conditions outside the building, and if the input readings during the defined time period cross one or two of the one or more threshold values, sending a tint command to transition the tintable window from a first tint state toward a second tint state and not transitioning further during a lockout period.

Certain implementations are directed to controllers for controlling tint of a tintable window in a building. In various aspects, the controllers comprise a pulse width modulator and a processor in communication with the pulse width modulator. The pulse width modulator is in communication with the tintable window and configured to send a signal with tint instructions to transition tint of the tintable window when a tint command is received. The processor is configured to define one or more threshold values of environmental conditions across a defined time period, define two or more discrete tint state values for the tintable window, receive input readings of actual conditions outside the building, and if the input readings during the defined time period cross one or two threshold values, send the signal with tint instructions to the pulse width modulator to transition the tintable window from a first tint state toward a second tint state and not transition further during a lockout period.

These and other features and embodiments will be described in more detail below with reference to the drawings.

### BRIEF DESCRIPTION OF THE DRAWINGS

FIGS. 1A-1C show schematic diagrams of electrochromic devices formed on glass substrates, i.e., electrochromic lites.

FIGS. 2A and 2B show cross-sectional schematic diagrams of the electrochromic lites as described in relation to FIGS. 1A-1C integrated into an IGU.

FIG. 3A depicts a schematic cross-section of an electrochromic device.

FIG. 3B depicts a schematic cross-section of an electrochromic device in a bleached state (or transitioning to a bleached state).

FIG. 3C depicts a schematic cross-section of the electrochromic device shown in FIG. 3B, but in a colored state (or transitioning to a colored state).

FIG. 4 depicts a simplified block diagram of components of a window controller.

FIG. 5 depicts a schematic diagram of a room including a tintable window and at least one sensor, according to disclosed embodiments.

FIGS. 6A-6C include diagrams depicting information collected by each of three Modules A, B, and C of an exemplary control logic, according to disclosed embodiments.

FIG. 7 is a flowchart showing control logic for a method of controlling one or more electrochromic windows in a building, according to embodiments.

FIG. 8 is a graph depicting an example of results from a thresholding operation of control logic, according to an embodiment.

FIG. 9 is a graph illustrating tinting decisions of control logic implementing a method that uses tint averaging over the wait time to control a tintable window, according to an embodiment.

FIG. 10 is a graph illustrating tinting decisions of control logic implementing a method for controlling a tintable window, according to an embodiment.

FIG. 11A is a graph illustrating tinting decisions of control logic implementing a method that does not include tail correction, according to an embodiment.

FIG. 11B is a graph illustrating tinting decisions of control logic implementing a method that includes tail correction, according to an embodiment.

FIGS. 12A, 12B, and 12C are three graphs illustrating the performance of a method implemented by control logic in a sunny condition, intermittent cloud cover condition, and cloudy to sunny condition, according to an embodiment.

FIGS. 13A, 13B, and 13C are three graphs illustrating the performance of a method implemented by control logic in a sunny condition, intermittent cloud cover condition, and cloudy to sunny condition, according to an embodiment.

FIG. 14 depicts a graph illustrating the performance of a method implemented by control logic, according to an embodiment.

FIG. 15 depicts a graph illustrating the performance of a method implemented by control logic, according to an embodiment.

FIG. 16 depicts a graph illustrating the performance of a method implemented by control logic, according to an embodiment.

FIG. 17 depicts a graph illustrating the performance of a method implemented by control logic, according to an embodiment.

FIG. 18 depicts a graph illustrating the performance of a method implemented by control logic, according to an embodiment.

FIG. 19 depicts a graph illustrating the performance of a method implemented by control logic, according to an embodiment.

FIG. 20 depicts a graph illustrating the performance of a method implemented by control logic, according to an embodiment.

FIG. 21 depicts a graph of micro-oscillations.

FIG. 22 depicts a graph of macro-oscillations for comparison with the micro-oscillations in FIG. 21.

FIG. 23 depicts an example of a photosensor curve with tail regimes defined by predefined offsets, according to an embodiment.

FIG. 24 depicts an example of a photosensor curve for partly cloudy conditions, cloudy conditions, and sunny condition, according to an embodiment.

FIG. 25 depicts an example of an occupancy lookup table, according to an embodiment.

FIG. 26A depicts an example of a confidence matrix, according to an embodiment.

FIG. 26B depicts an example of a confidence matrix, according to an embodiment.

FIG. 27 depicts a graph illustrating the performance of a method implemented by control logic, according to an embodiment.

FIG. 28 depicts a schematic diagram of an embodiment of a BMS, according to an embodiment.

FIG. 29 is a block diagram of components of a system for controlling functions of one or more tintable windows of a building, according to embodiments.

### DETAILED DESCRIPTION

In the following description, numerous specific details are set forth in order to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

I. Overview of Electrochromic Devices

It should be understood that while disclosed embodiments focus on electrochromic windows (also referred to as smart windows), the concepts disclosed herein may apply to other types of tintable windows. For example, a tintable window incorporating a liquid crystal device or a suspended particle device, instead of an electrochromic device could be incorporated in any of the disclosed embodiments.

In order to orient the reader to the embodiments of systems, window controllers, and methods disclosed herein, a brief discussion of electrochromic devices is provided. This initial discussion of electrochromic devices is provided for context only, and the subsequently described embodiments of systems, window controllers, and methods are not limited to the specific features and fabrication processes of this initial discussion.

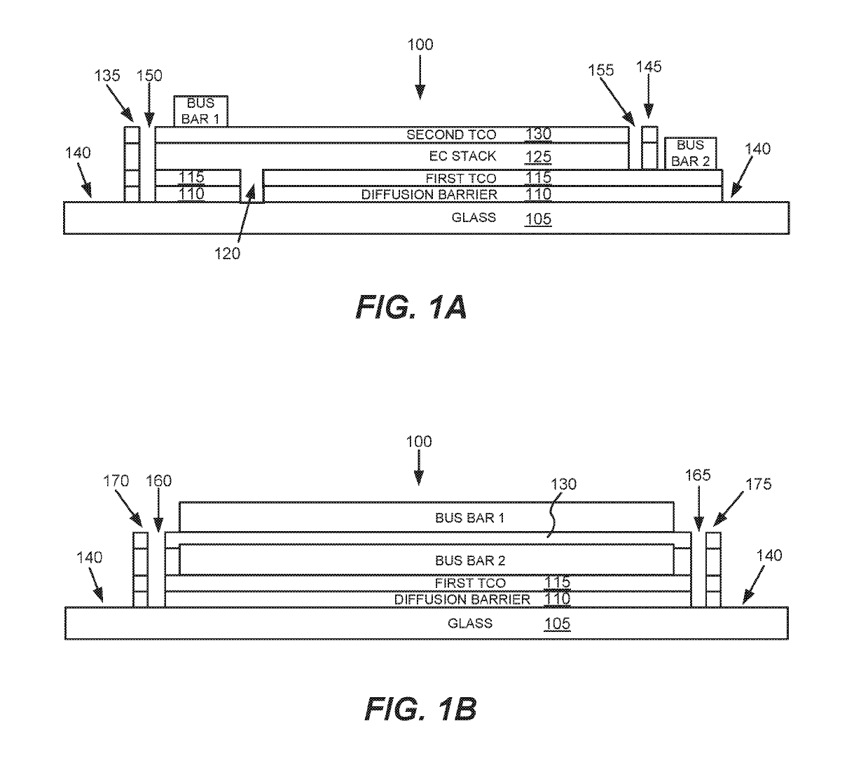

A particular example of an electrochromic lite is described with reference to FIGS. 1A-1C, in order to illustrate embodiments described herein. FIG. 1A is a cross-sectional representation (see section cut X′-X′ of FIG. 1C) of an electrochromic lite 100, which is fabricated starting with a glass sheet 105. FIG. 1B shows an end view (see viewing perspective Y-Y′ of FIG. 1C) of electrochromic lite 100, and FIG. 1C shows a top-down view of electrochromic lite 100. FIG. 1A shows the electrochromic lite after fabrication on glass sheet 105, edge deleted to produce area 140, around the perimeter of the lite. The electrochromic lite has also been laser scribed and bus bars have been attached. The glass lite 105 has a diffusion barrier 110, and a first transparent conducting oxide layer (TCO) 115, on the diffusion barrier. In this example, the edge deletion process removes both TCO 115 and diffusion barrier 110, but in other embodiments only the TCO is removed, leaving the diffusion barrier intact. The TCO 115 is the first of two conductive layers used to form the electrodes of the electrochromic device fabricated on the glass sheet. In this example, the glass sheet includes underlying glass and the diffusion barrier layer. Thus, in this example, the diffusion barrier is formed, and then the first TCO, an electrochromic stack 125, (e.g., having electrochromic, ion conductor, and counter electrode layers), and a second TCO 130, are formed. In one embodiment, the electrochromic device (electrochromic stack and second TCO) is fabricated in an integrated deposition system where the glass sheet does not leave the integrated deposition system at any time during fabrication of the stack. In one embodiment, the first TCO layer is also formed using the integrated deposition system where the glass sheet does not leave the integrated deposition system during deposition of the electrochromic stack and the (second) TCO layer. In one embodiment, all of the layers (diffusion barrier, first TCO, electrochromic stack, and second TCO) are deposited in the integrated deposition system where the glass sheet does not leave the integrated deposition system during deposition. In this example, prior to deposition of electrochromic stack 125, an isolation trench 120, is cut through TCO 115 and diffusion barrier 110. Trench 120 is made in contemplation of electrically isolating an area of TCO 115 that will reside under bus bar 1 after fabrication is complete (see FIG. 1A). This is done to avoid charge buildup and coloration of the electrochromic device under the bus bar, which can be undesirable.

After formation of the electrochromic device, edge deletion processes and additional laser scribing are performed. FIG. 1A depicts areas 140 where the device has been removed, in this example, from a perimeter region surrounding laser scribe trenches 150, 155, 160, and 165. Trenches 150, 160 and 165 pass through the electrochromic stack and also through the first TCO and diffusion barrier. Trench 155 passes through second TCO 130 and the electrochromic stack, but not the first TCO 115. Laser scribe trenches 150, 155, 160, and 165 are made to isolate portions of the electrochromic device, 135, 145, 170, and 175, which were potentially damaged during edge deletion processes from the operable electrochromic device. In this example, laser scribe trenches 150, 160, and 165 pass through the first TCO to aid in isolation of the device (laser scribe trench 155 does not pass through the first TCO, otherwise it would cut off bus bar 2's electrical communication with the first TCO and thus the electrochromic stack). The laser or lasers used for the laser scribe processes are typically, but not necessarily, pulse-type lasers, for example, diode-pumped solid state lasers. For example, the laser scribe processes can be performed using a suitable laser from IPG Photonics (of Oxford, Mass.), or from Ekspla (of Vilnius, Lithuania). Scribing can also be performed mechanically, for example, by a diamond tipped scribe. One of ordinary skill in the art would appreciate that the laser scribing processes can be performed at different depths and/or performed in a single process whereby the laser cutting depth is varied, or not, during a continuous path around the perimeter of the electrochromic device. In one embodiment, the edge deletion is performed to the depth of the first TCO.

After laser scribing is complete, bus bars are attached. Non-penetrating bus bar 1 is applied to the second TCO. Non-penetrating bus bar 2 is applied to an area where the device was not deposited (e.g., from a mask protecting the first TCO from device deposition), in contact with the first TCO or, in this example, where an edge deletion process (e.g., laser ablation using an apparatus having a XY or XYZ galvanometer) was used to remove material down to the first TCO. In this example, both bus bar 1 and bus bar 2 are non-penetrating bus bars. A penetrating bus bar is one that is typically pressed into and through the electrochromic stack to make contact with the TCO at the bottom of the stack. A non-penetrating bus bar is one that does not penetrate into the electrochromic stack layers, but rather makes electrical and physical contact on the surface of a conductive layer, for example, a TCO.

The TCO layers can be electrically connected using a non-traditional bus bar, for example, a bus bar fabricated with screen and lithography patterning methods. In one embodiment, electrical communication is established with the device's transparent conducting layers via silk screening (or using another patterning method) a conductive ink followed by heat curing or sintering the ink. Advantages to using the above described device configuration include simpler manufacturing, for example, and less laser scribing than conventional techniques which use penetrating bus bars.

After the bus bars are connected, the device is integrated into an insulated glass unit (IGU), which includes, for example, wiring the bus bars and the like. In some embodiments, one or both of the bus bars are inside the finished IGU, however in one embodiment one bus bar is outside the seal of the IGU and one bus bar is inside the IGU. In the former embodiment, area 140 is used to make the seal with one face of the spacer used to form the IGU. Thus, the wires or other connection to the bus bars runs between the spacer and the glass. As many spacers are made of metal, e.g., stainless steel, which is conductive, it is desirable to take steps to avoid short circuiting due to electrical communication between the bus bar and connector thereto and the metal spacer.

As described above, after the bus bars are connected, the electrochromic lite is integrated into an IGU, which includes, for example, wiring for the bus bars and the like. In the embodiments described herein, both of the bus bars are inside the primary seal of the finished IGU.

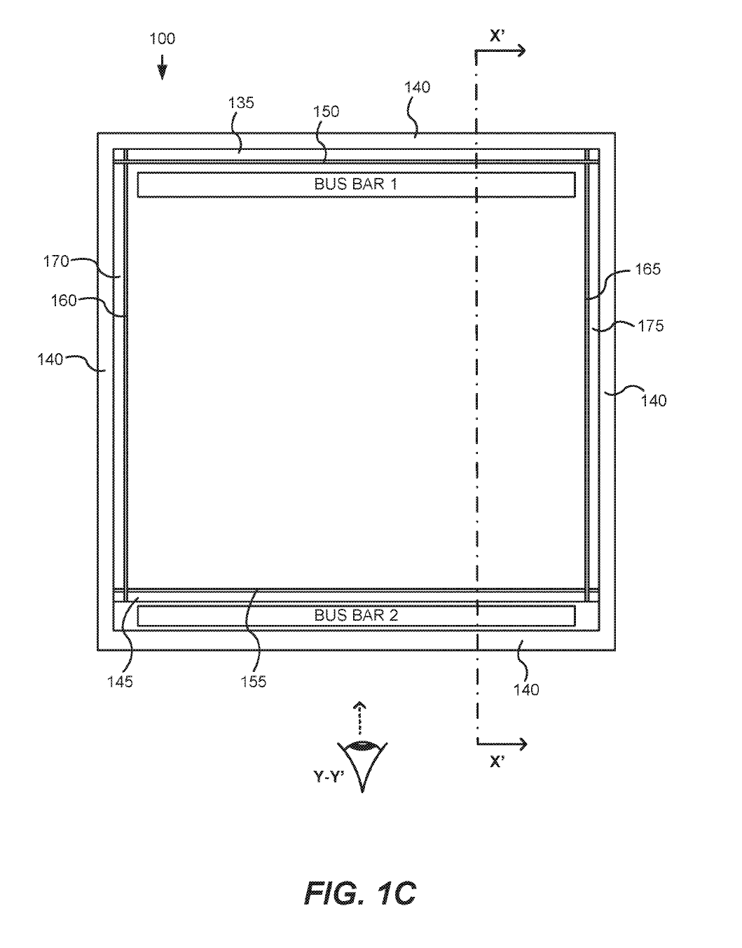

FIG. 2A shows a cross-sectional schematic diagram of the electrochromic window as described in relation to FIGS. 1A-1C integrated into an IGU 200. A spacer 205 is used to separate the electrochromic lite from a second lite 210. Second lite 210 in IGU 200 is a non-electrochromic lite, however, the embodiments disclosed herein are not so limited. For example, lite 210 can have an electrochromic device thereon and/or one or more coatings such as low-E coatings and the like. Lite 201 can also be laminated glass, such as depicted in FIG. 2B (lite 201 is laminated to reinforcing pane 230, via resin 235). Between spacer 205 and the first TCO layer of the electrochromic lite is a primary seal material 215. This primary seal material is also between spacer 205 and second glass lite 210. Around the perimeter of spacer 205 is a secondary seal 220. Bus bar wiring/leads traverse the seals for connection to a controller. Secondary seal 220 may be much thicker that depicted. These seals aid in keeping moisture out of an interior space 225, of the IGU. They also serve to prevent argon or other gas in the interior of the IGU from escaping.

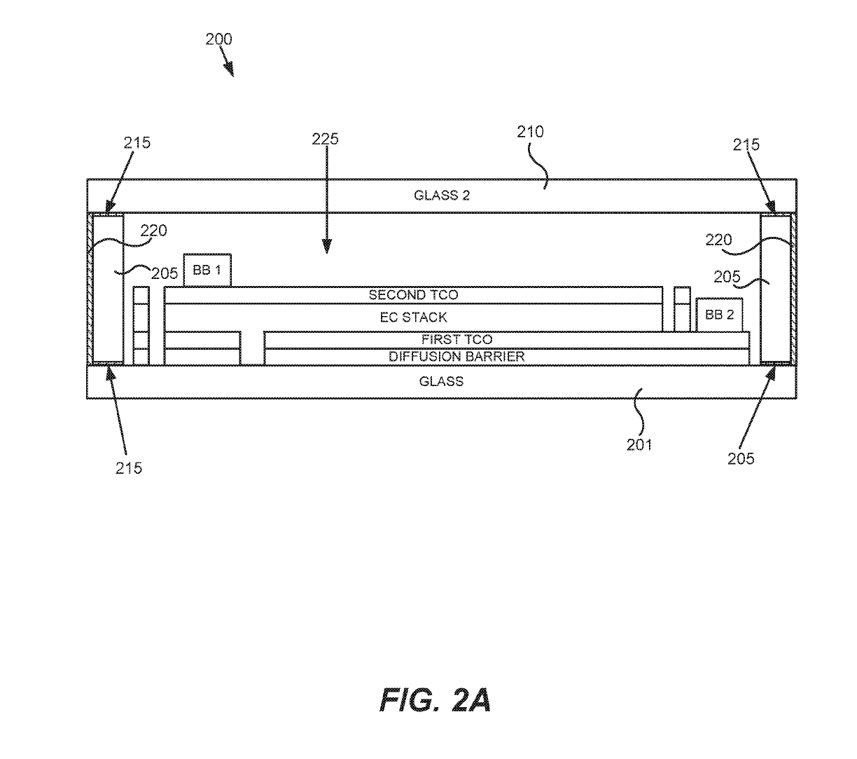

FIG. 3A schematically depicts an electrochromic device 300, in cross-section. Electrochromic device 300 includes a substrate 302, a first conductive layer (CL) 304, an electrochromic layer (EC) 306, an ion conducting layer (IC) 308, a counter electrode layer (CE) 310, and a second conductive layer (CL) 314. Layers 304, 306, 308, 310, and 314 are collectively referred to as an electrochromic stack 320. A voltage source 316 operable to apply an electric potential across electrochromic stack 320 effects the transition of the electrochromic device from, for example, a bleached state to a colored state (depicted). The order of layers can be reversed with respect to the substrate.

Electrochromic devices having distinct layers as described can be fabricated as all solid state devices and/or all inorganic devices having low defectivity. Such devices and methods of fabricating them are described in more detail in U.S. patent application Ser. No. 12/645,111, entitled “Fabrication of Low-Defectivity Electrochromic Devices,” filed on Dec. 22, 2009, and naming Mark Kozlowski et al. as inventors, and in U.S. patent application Ser. No. 12/645,159, entitled, “Electrochromic Devices,” filed on Dec. 22, 2009 and naming Zhongchun Wang et al. as inventors, both of which are hereby incorporated by reference in their entireties. It should be understood, however, that any one or more of the layers in the stack may contain some amount of organic material. The same can be said for liquids that may be present in one or more layers in small amounts. It should also be understood that solid state material may be deposited or otherwise formed by processes employing liquid components such as certain processes employing sol-gels or chemical vapor deposition.

Additionally, it should be understood that the reference to a transition between a bleached state and colored state is non-limiting and suggests only one example, among many, of an electrochromic transition that may be implemented. Unless otherwise specified herein (including the foregoing discussion), whenever reference is made to a bleached-colored transition, the corresponding device or process encompasses other optical state transitions such as non-reflective-reflective, transparent-opaque, etc. Further, the term “bleached” refers to an optically neutral state, for example, uncolored, transparent, or translucent. Still further, unless specified otherwise herein, the “color” of an electrochromic transition is not limited to any particular wavelength or range of wavelengths. As understood by those of skill in the art, the choice of appropriate electrochromic and counter electrode materials governs the relevant optical transition.

In embodiments described herein, the electrochromic device reversibly cycles between a bleached state and a colored state. In some cases, when the device is in a bleached state, a potential is applied to the electrochromic stack 320 such that available ions in the stack reside primarily in the counter electrode 310. When the potential on the electrochromic stack is reversed, the ions are transported across the ion conducting layer 308 to the electrochromic material 306 and cause the material to transition to the colored state. In a similar way, the electrochromic device of embodiments described herein can be reversibly cycled between different tint levels (e.g., bleached state, darkest colored state, and intermediate levels between the bleached state and the darkest colored state).

Referring again to FIG. 3A, voltage source 316 may be configured to operate in conjunction with radiant and other environmental sensors. As described herein, voltage source 316 interfaces with a device controller (not shown in this figure). Additionally, voltage source 316 may interface with an energy management system that controls the electrochromic device according to various criteria such as the time of year, time of day, and measured environmental conditions. Such an energy management system, in conjunction with large area electrochromic devices (e.g., an electrochromic window), can dramatically lower the energy consumption of a building.

Any material having suitable optical, electrical, thermal, and mechanical properties may be used as substrate 302. Such substrates include, for example, glass, plastic, and mirror materials. Suitable glasses include either clear or tinted soda lime glass, including soda lime float glass. The glass may be tempered or untempered.

In many cases, the substrate is a glass pane sized for residential window applications. The size of such glass pane can vary widely depending on the specific needs of the residence. In other cases, the substrate is architectural glass. Architectural glass is typically used in commercial buildings, but may also be used in residential buildings, and typically, though not necessarily, separates an indoor environment from an outdoor environment. In certain embodiments, architectural glass is at least 20 inches by 20 inches, and can be much larger, for example, as large as about 80 inches by 120 inches. Architectural glass is typically at least about 2 mm thick, typically between about 3 mm and about 6 mm thick. Of course, electrochromic devices are scalable to substrates smaller or larger than architectural glass. Further, the electrochromic device may be provided on a mirror of any size and shape.

On top of substrate 302 is conductive layer 304. In certain embodiments, one or both of the conductive layers 304 and 314 is inorganic and/or solid. Conductive layers 304 and 314 may be made from a number of different materials, including conductive oxides, thin metallic coatings, conductive metal nitrides, and composite conductors. Typically, conductive layers 304 and 314 are transparent at least in the range of wavelengths where electrochromism is exhibited by the electrochromic layer. Transparent conductive oxides include metal oxides and metal oxides doped with one or more metals. Examples of such metal oxides and doped metal oxides include indium oxide, indium tin oxide, doped indium oxide, tin oxide, doped tin oxide, zinc oxide, aluminum zinc oxide, doped zinc oxide, ruthenium oxide, doped ruthenium oxide and the like. Since oxides are often used for these layers, they are sometimes referred to as “transparent conductive oxide” (TCO) layers. Thin metallic coatings that are substantially transparent may also be used, as well as combinations of TCOs and metallic coatings.

The function of the conductive layers is to spread an electric potential provided by voltage source 316 over surfaces of the electrochromic stack 320 to interior regions of the stack, with relatively little ohmic potential drop. The electric potential is transferred to the conductive layers though electrical connections to the conductive layers. In some embodiments, bus bars, one in contact with conductive layer 304 and one in contact with conductive layer 314, provide the electric connection between the voltage source 316 and the conductive layers 304 and 314. The conductive layers 304 and 314 may also be connected to the voltage source 316 with other conventional means.

Overlaying conductive layer 304 is electrochromic layer 306. In some embodiments, electrochromic layer 306 is inorganic and/or solid. The electrochromic layer may contain any one or more of a number of different electrochromic materials, including metal oxides. Such metal oxides include tungsten oxide (WO₃), molybdenum oxide (MoO₃), niobium oxide (Nb₂O₅), titanium oxide (TiO₂), copper oxide (CuO), iridium oxide (Ir₂O₃), chromium oxide (Cr₂O₃), manganese oxide (Mn₂O₃), vanadium oxide (V₂O₅), nickel oxide (Ni₂O₃), cobalt oxide (Co₂O₃) and the like. During operation, the electrochromic layer 306 transfers ions to and receives ions from counter electrode layer 310 to cause optical transitions.

Generally, the colorization (or change in any optical property—e.g., absorbance, reflectance, and transmittance) of the electrochromic material is caused by reversible ion insertion into the material (e.g., intercalation) and a corresponding injection of a charge balancing electron. Typically some fraction of the ions responsible for the optical transition is irreversibly bound up in the electrochromic material. Some or all of the irreversibly bound ions are used to compensate “blind charge” in the material. In most electrochromic materials, suitable ions include lithium ions (Li+) and hydrogen ions (H+) (that is, protons). In some cases, however, other ions will be suitable. In various embodiments, lithium ions are used to produce the electrochromic phenomena. Intercalation of lithium ions into tungsten oxide (WO3-y (0<y≤˜0.3)) causes the tungsten oxide to change from transparent (bleached state) to blue (colored state).

Referring again to FIG. 3A, in electrochromic stack 320, ion conducting layer 308 is sandwiched between electrochromic layer 306 and counter electrode layer 310. In some embodiments, counter electrode layer 310 is inorganic and/or solid. The counter electrode layer may comprise one or more of a number of different materials that serve as a reservoir of ions when the electrochromic device is in the bleached state. During an electrochromic transition initiated by, for example, application of an appropriate electric potential, the counter electrode layer transfers some or all of the ions it holds to the electrochromic layer, changing the electrochromic layer to the colored state. Concurrently, in the case of NiWO, the counter electrode layer colors with the loss of ions.

In some embodiments, suitable materials for the counter electrode complementary to WO3 include nickel oxide (NiO), nickel tungsten oxide (NiWO), nickel vanadium oxide, nickel chromium oxide, nickel aluminum oxide, nickel manganese oxide, nickel magnesium oxide, chromium oxide (Cr₂O₃), manganese oxide (MnO₂), and Prussian blue.

When charge is removed from a counter electrode 310 made of nickel tungsten oxide (that is, ions are transported from counter electrode 310 to electrochromic layer 306), the counter electrode layer will transition from a transparent state to a colored state.

In the depicted electrochromic device, between electrochromic layer 306 and counter electrode layer 310, there is the ion conducting layer 308. Ion conducting layer 308 serves as a medium through which ions are transported (in the manner of an electrolyte) when the electrochromic device transitions between the bleached state and the colored state. Preferably, ion conducting layer 308 is highly conductive to the relevant ions for the electrochromic and the counter electrode layers, but has sufficiently low electron conductivity that negligible electron transfer takes place during normal operation. A thin ion conducting layer with high ionic conductivity permits fast ion conduction and hence fast switching for high performance electrochromic devices. In certain embodiments, the ion conducting layer 308 is inorganic and/or solid.

Examples of suitable ion conducting layers (for electrochromic devices having a distinct IC layer) include silicates, silicon oxides, tungsten oxides, tantalum oxides, niobium oxides, and borates. These materials may be doped with different dopants, including lithium. Lithium doped silicon oxides include lithium silicon-aluminum-oxide. In some embodiments, the ion conducting layer comprises a silicate-based structure. In some embodiments, a silicon-aluminum-oxide (SiAlO) is used for the ion conducting layer 308.

Electrochromic device 300 may include one or more additional layers (not shown), such as one or more passive layers. Passive layers used to improve certain optical properties may be included in electrochromic device 300. Passive layers for providing moisture or scratch resistance may also be included in electrochromic device 300. For example, the conductive layers may be treated with anti-reflective or protective oxide or nitride layers. Other passive layers may serve to hermetically seal electrochromic device 300.

FIG. 3B is a schematic cross-section of an electrochromic device in a bleached state (or transitioning to a bleached state). In accordance with specific embodiments, an electrochromic device 400 includes a tungsten oxide electrochromic layer (EC) 406 and a nickel-tungsten oxide counter electrode layer (CE) 410. Electrochromic device 400 also includes a substrate 402, a conductive layer (CL) 404, an ion conducting layer (IC) 408, and conductive layer (CL) 414.

A power source 416 is configured to apply a potential and/or current to an electrochromic stack 420 through suitable connections (e.g., bus bars) to the conductive layers 404 and 414. In some embodiments, the voltage source is configured to apply a potential of a few volts in order to drive a transition of the device from one optical state to another. The polarity of the potential as shown in FIG. 3A is such that the ions (lithium ions in this example) primarily reside (as indicated by the dashed arrow) in nickel-tungsten oxide counter electrode layer 410

FIG. 3C is a schematic cross-section of electrochromic device 400 shown in FIG. 3B but in a colored state (or transitioning to a colored state). In FIG. 3C, the polarity of voltage source 416 is reversed, so that the electrochromic layer is made more negative to accept additional lithium ions, and thereby transition to the colored state. As indicated by the dashed arrow, lithium ions are transported across ion conducting layer 408 to tungsten oxide electrochromic layer 406. Tungsten oxide electrochromic layer 406 is shown in the colored state. Nickel-tungsten oxide counter electrode 410 is also shown in the colored state. As explained, nickel-tungsten oxide becomes progressively more opaque as it gives up (deintercalates) lithium ions. In this example, there is a synergistic effect where the transition to colored states for both layers 406 and 410 are additive toward reducing the amount of light transmitted through the stack and substrate.

As described above, an electrochromic device may include an electrochromic (EC) electrode layer and a counter electrode (CE) layer separated by an ionically conductive (IC) layer that is highly conductive to ions and highly resistive to electrons. As conventionally understood, the ionically conductive layer therefore prevents shorting between the electrochromic layer and the counter electrode layer. The ionically conductive layer allows the electrochromic and counter electrodes to hold a charge and thereby maintain their bleached or colored states. In electrochromic devices having distinct layers, the components form a stack which includes the ion conducting layer sandwiched between the electrochromic electrode layer and the counter electrode layer. The boundaries between these three stack components are defined by abrupt changes in composition and/or microstructure. Thus, the devices have three distinct layers with two abrupt interfaces.

In accordance with certain embodiments, the counter electrode and electrochromic electrodes are formed immediately adjacent one another, sometimes in direct contact, without separately depositing an ionically conducting layer. In some embodiments, electrochromic devices having an interfacial region rather than a distinct IC layer are employed. Such devices, and methods of fabricating them, are described in U.S. Pat. No. 8,300,298 and U.S. patent application Ser. No. 12/772,075 filed on Apr. 30, 2010, and U.S. patent application Ser. Nos. 12/814,277 and 12/814,279, filed on Jun. 11, 2010—each of the three patent applications and patent is entitled “Electrochromic Devices,” each names Zhongchun Wang et al. as inventors, and each is incorporated by reference herein in its entirety.

II. Window Controllers

A window controller is used to control the tint level of the electrochromic device of an electrochromic window. In some embodiments, the window controller is able to transition the electrochromic window between two tint states (levels), a bleached state and a colored state. In other embodiments, the controller can additionally transition the electrochromic window (e.g., having a single electrochromic device) to intermediate tint levels. In some disclosed embodiments, the window controller is able to transition the electrochromic window to four or more tint levels. Certain electrochromic windows allow intermediate tint levels by using two (or more) electrochromic lites in a single IGU, where each lite is a two-state lite. This is described in reference to FIGS. 2A and 2B in this section.

As noted above with respect to FIGS. 2A and 2B, in some embodiments, an electrochromic window can include an electrochromic device 400 on one lite of an IGU 200 and another electrochromic device 400 on the other lite of the IGU 200. If the window controller is able to transition each electrochromic device between two states, a bleached state and a colored state, the electrochromic window is able to attain four different states (tint levels), a colored state with both electrochromic devices being colored, a first intermediate state with one electrochromic device being colored, a second intermediate state with the other electrochromic device being colored, and a bleached state with both electrochromic devices being bleached. Embodiments of multi-pane electrochromic windows are further described in U.S. Pat. No. 8,270,059, naming Robin Friedman et al. as inventors, titled “MULTI-PANE ELECTROCHROMIC WINDOWS,” which is hereby incorporated by reference in its entirety.

In some embodiments, the window controller is able to transition an electrochromic window having an electrochromic device capable of transitioning between two or more tint levels. For example, a window controller may be able to transition the electrochromic window to a bleached state, one or more intermediate levels, and a colored state. In some other embodiments, the window controller is able to transition an electrochromic window incorporating an electrochromic device between any number of tint levels between the bleached state and the colored state. Embodiments of methods and controllers for transitioning an electrochromic window to an intermediate tint level or levels are further described in U.S. Pat. No. 8,254,013, naming Disha Mehtani et al. as inventors, titled “CONTROLLING TRANSITIONS IN OPTICALLY SWITCHABLE DEVICES,” which is hereby incorporated by reference in its entirety.

In some embodiments, a window controller can power one or more electrochromic devices in an electrochromic window. Typically, this function of the window controller is augmented with one or more other functions described in more detail below. Window controllers described herein are not limited to those that have the function of powering an electrochromic device to which it is associated for the purposes of control. That is, the power source for the electrochromic window may be separate from the window controller, where the controller has its own power source and directs application of power from the window power source to the window. However, it is convenient to include a power source with the window controller and to configure the controller to power the window directly, because it obviates the need for separate wiring for powering the electrochromic window.

Further, the window controllers described in this section are described as standalone controllers which may be configured to control the functions of a single window or a plurality of electrochromic windows, without integration of the window controller into a building control network or a building management system (BMS). Window controllers, however, may be integrated into a building control network or a BMS, as described further in the Building Management System section of this disclosure.

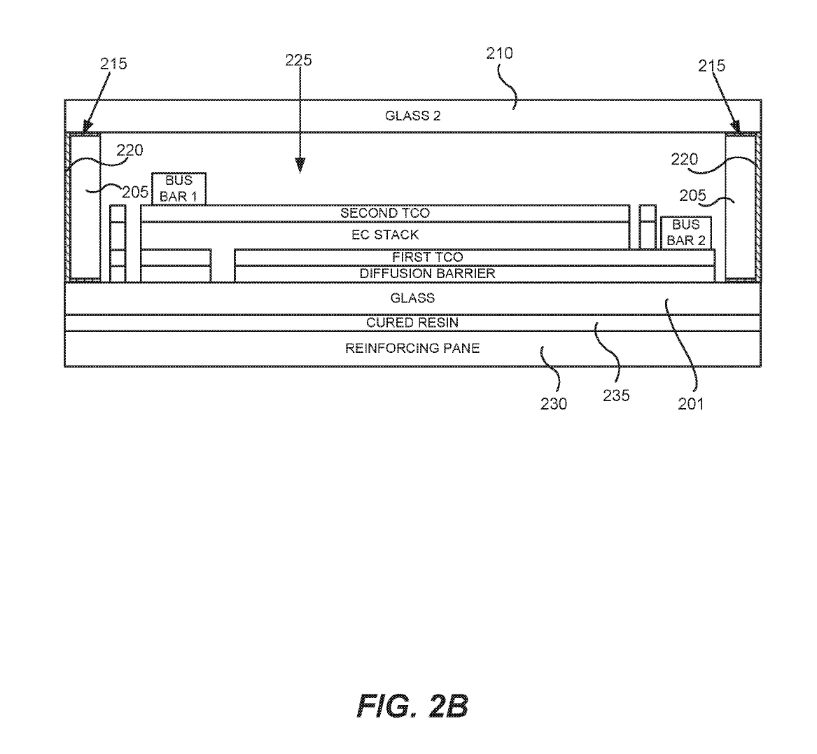

FIG. 4 depicts a block diagram of some components of a window controller 450 and other components of a window controller system of disclosed embodiments. FIG. 4 is a simplified block diagram of a window controller, and more detail regarding window controllers can be found in U.S. patent application Ser. Nos. 13/449,248 and 13/449,251, both naming Stephen Brown as inventor, both titled “CONTROLLER FOR OPTICALLY-SWITCHABLE WINDOWS,” and both filed on Apr. 17, 2012, and in U.S. patent Ser. No. 13/449,235, titled “CONTROLLING TRANSITIONS IN OPTICALLY SWITCHABLE DEVICES,” naming Stephen Brown et al. as inventors and filed on Apr. 17, 2012, all of which are hereby incorporated by reference in their entireties.

In FIG. 4, the illustrated components of the window controller 450 include a window controller 450 having a microprocessor 455 or other processor, a pulse width modulator 460, a signal conditioning module 465, and a computer readable medium (e.g., memory) having a configuration file 475. Window controller 450 is in electronic communication with one or more electrochromic devices 400 in an electrochromic window through network 480 (wired or wireless) to send instructions to the one or more electrochromic devices 400. In some embodiments, the window controller 450 may be a local window controller in communication through a network (wired or wireless) to a master window controller.

In disclosed embodiments, a building may have at least one room having an electrochromic window between the exterior and interior of a building. One or more sensors may be located to the exterior of the building and/or inside the room. In embodiments, the output from the one or more sensors may be input to the signal conditioning module 465 of the window controller 450. In some cases, the output from the one or more sensors may be input to a BMS, as described further in the Building Management Systems section. Although the sensors of depicted embodiments are shown as located on the outside vertical wall of the building, this is for the sake of simplicity, and the sensors may be in other locations, such as inside the room or on other surfaces to the exterior, as well. In some cases, two or more sensors may be used to measure the same input, which can provide redundancy in case one sensor fails or has an otherwise erroneous reading.

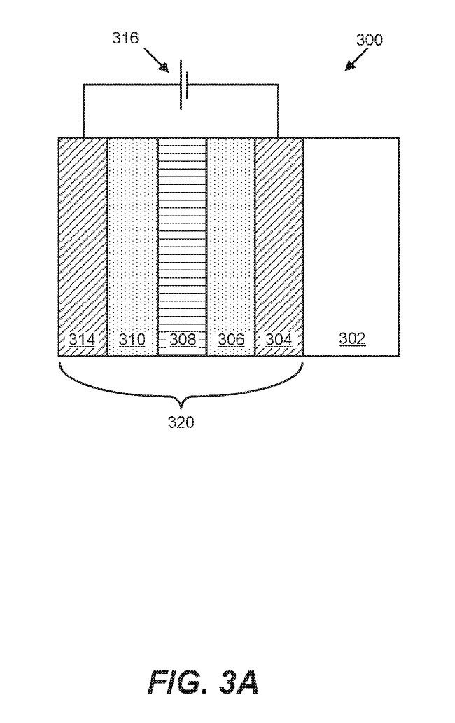

FIG. 5 depicts a schematic (side view) diagram of a room 500 having an electrochromic window 505 with at least one electrochromic device. The electrochromic window 505 is located between the exterior and the interior of a building, which includes the room 500. The room 500 also includes a window controller 450 connected to and configured to control the tint level of the electrochromic window 505. An exterior sensor 510 is located on a vertical surface in the exterior of the building. In other embodiments, an interior sensor may also be used to measure the ambient light in room 500. In yet other embodiments, an occupant sensor may also be used to determine when an occupant is in the room 500.

Exterior sensor 510 is a device, such as a photosensor, that is able to detect radiant light incident upon the device flowing from a light source such as the sun or from light reflected to the sensor from a surface, particles in the atmosphere, clouds, etc. The exterior sensor 510 may generate a signal in the form of electrical current that results from the photoelectric effect and the signal may be a function of the light incident on the sensor 510. In some cases, the device may detect radiant light in terms of irradiance in units of watts/m² or other similar units. In other cases, the device may detect light in the visible range of wavelengths in units of foot candles or similar units. In many cases, there is a linear relationship between these values of irradiance and visible light.

Irradiance values from sunlight can be calculated based on the time of day and time of year as the angle at which sunlight strikes the earth changes. Exterior sensor 510 can detect radiant light in real-time, which accounts for reflected and obstructed light due to buildings, changes in weather (e.g., clouds), etc. For example, on cloudy days, sunlight would be blocked by the clouds and the radiant light detected by an exterior sensor 510 would be lower than on cloudless days.

In some embodiments, there may be one or more exterior sensors 510 associated with a single electrochromic window 505. Output from the one or more exterior sensors 510 could be compared to one another to determine, for example, if one of exterior sensors 510 is shaded by an object, such as by a bird that landed on exterior sensor 510. In some cases, it may be desirable to use relatively few sensors in a building because some sensors can be unreliable and/or expensive. In certain implementations, a single sensor or a few sensors may be employed to determine the current level of radiant light from the sun impinging on the building or perhaps one side of the building. A cloud may pass in front of the sun or a construction vehicle may park in front of the setting sun. These will result in deviations from the amount of radiant light from the sun calculated to normally impinge on the building.

Exterior sensor 510 may be a type of photosensor. For example, exterior sensor 510 may be a charge coupled device (CCD), photodiode, photoresistor, or photovoltaic cell. One of ordinary skill in the art would appreciate that future developments in photosensor and other sensor technology would also work, as they measure light intensity and provide an electrical output representative of the light level.

In some embodiments, output from exterior sensor 510 may be input to the signal conditioning module 465. The input may be in the form of a voltage signal to signal conditioning module 465. Signal conditioning module 465 passes an output signal to the window controller 450. Window controller 450 determines a tint level of the electrochromic window 505, based on various information from the configuration file 475, output from the signal conditioning module 465, override values. Window controller 450 then instructs the PWM 460 to apply a voltage and/or current to electrochromic window 505 to transition to the desired tint level.

In disclosed embodiments, the window controller 450 can instruct the PWM 460 to apply a voltage and/or current to electrochromic window 505 to transition it to any one of four or more different tint levels. In disclosed embodiments, electrochromic window 505 can be transitioned to at least eight different tint levels described as: 0 (lightest), 5, 10, 15, 20, 25, 30, and 35 (darkest). The tint levels may linearly correspond to visual transmittance values and solar heat gain coefficient (SHGC) values of light transmitted through the electrochromic window 505. For example, using the above eight tint levels, the lightest tint level of 0 may correspond to an SHGC value of 0.80, the tint level of 5 may correspond to an SHGC value of 0.70, the tint level of 10 may correspond to an SHGC value of 0.60, the tint level of 15 may correspond to an SHGC value of 0.50, the tint level of 20 may correspond to an SHGC value of 0.40, the tint level of 25 may correspond to an SHGC value of 0.30, the tint level of 30 may correspond to an SHGC value of 0.20, and the tint level of 35 (darkest) may correspond to an SHGC value of 0.10.

Window controller 450 or a master controller in communication with the window controller 450 may employ any one or more control logic components to determine a desired tint level based on signals from the exterior sensor 510 and/or other input. The window controller 450 can instruct the PWM 460 to apply a voltage and/or current to electrochromic window 505 to transition it to the desired tint level.

III. Introduction to Control Logic Implementing Intermediate Tint States

When using certain tint control techniques discussed above, the tint level of a tintable window might jump several tint levels when photosensor readings rose above a certain value and then the window could not initiate a new transition until the multi-level transition was complete. As a consequence, large area windows might be stuck in transitioning to an inappropriately high or low tint level for an extended period of time. These and similar methods could also clear windows too quickly at sunset or with a passing cloud and tint too quickly at sunrise.

The control logic implementing intermediate tint states described herein takes advantage of fast switching operations to transition to intermediate tint states and the capability of starting a new transition before the previous transition is complete in order to more smoothly adapt to current conditions. Generally speaking, the described control logic is used to implement methods that control tint transitions in an electrochromic window or other tintable window to account for occupant comfort and/or energy conservation considerations. These methods have a thresholding operation that determines whether photosensor readings have passed through a threshold value. These methods make tint decisions based on the thresholding results, send tint commands for controlling transitions in the tintable window, and do not make any further transitions (i.e. hold tint state) during a lockout period. In some cases, the methods make a tint decision that applies after the lockout period based on a statistically probably condition determined based on input data taken during the lockout period.

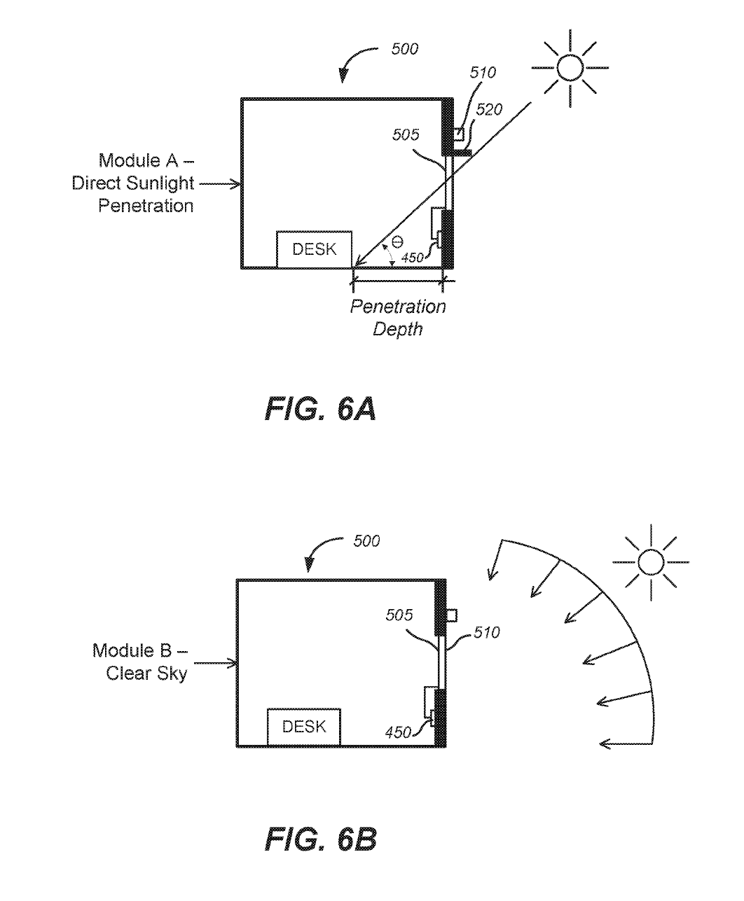

Across a period of a day, photosensors can be used to measure solar irradiance at a tintable window that can be used to determine current conditions outside the building. In addition or alternatively, other data, such as infrared readings, weather feed data, etc. can be used to determine current conditions. FIG. 9 depicts a graph illustrates a photosensor curve 970 of irradiance readings taken by a photosensor over time for a single day. As shown, the range of photosensor values is divided by threshold values, in this case, by a lower threshold value 920 of about 100 and an upper threshold value 922 of about 380. A “tint region” or “tint state assignable region” generally refers to an area between threshold values. That is, the threshold values determine the tint region boundaries. Each tint region can be assigned a single tint level or multiple tint levels. In FIG. 9, the first tint region is below the lower threshold value 920, the second tint region is between the lower threshold value 920 and the upper threshold value 922, and the third tint region is above the upper threshold value 922 where Module AB are used to determine the tint level.

The methods described herein determine the threshold values that apply based on the whether the current time is in a tail regime or a daytime regime. According to one aspect, tail regimes are at the end regions of the photosensor curve (i.e. photosensor readings over time) just after sunrise and just before sunset. A sunrise tail regime starts at sunrise and a sunset tail regime ends at sunset. In the sunrise tail regime, photosensor values on a sunny day go from completely dark before sunrise and in a short amount of time to very sunny with sunlight shining directly into room. In the sunset tail regime, photosensor values on a sunny day go from very sunny just before sunset to completely dark and in a short amount of time. For this reason, thresholding typically used in the daytime regime between the sunrise tail regime and the sunset tail regime is not as effective in the tail regions. The daytime regime lies between the sunrise tail regime and the sunset tail regime.

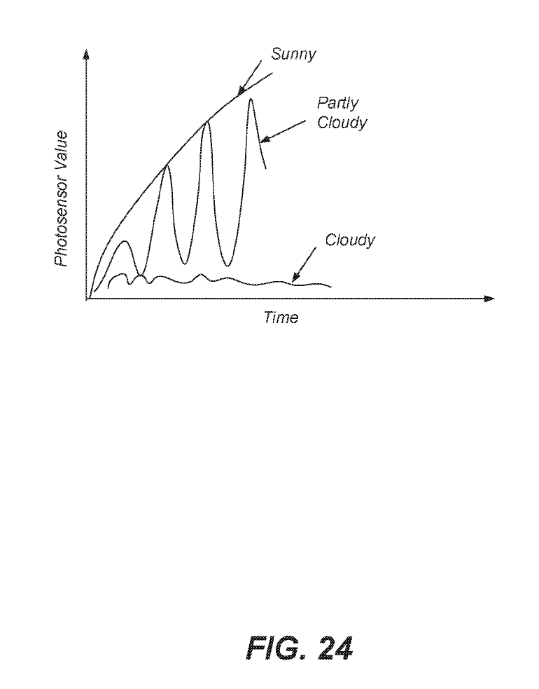

According to another aspect, a current time is determined to be in a tail regime or a daytime regime based on an evaluation of smoothness or discontinuity, oscillating frequency, and/or slope of a photosensor curve. For example, a partly cloudy condition may be determined if the sensor readings fluctuate widely (high frequency of oscillation) between low and high sensor readings, a cloudy condition may be determined if the sensor readings generally fluctuate between relatively low readings (lower frequency of oscillation and generally low value flat slope), and a sunny condition may be determined if the slope of the readings is steep and there is generally little to no oscillation. FIG. 24 shows examples of photosensor readings for sunny, partly cloudy and cloudy conditions. In one case, a method determines the current time is in the tail regime if the sensor readings suggest a cloudy condition or a partly cloudy condition and determine the current time is in the daytime regime if the sensor readings suggest a sunny condition. In another case, a method determines the current time is in the tail regime if the sensor readings suggest a cloudy condition and determine the current time is in the daytime regime if the sensor readings suggest a partly cloud or sunny condition.

In certain embodiments, the control methods make tint decisions by using photosensor readings and optionally other input to see whether a tint transition is suggested. For example, high solar irradiance readings above an upper threshold may indicate that it is clear sky and sunny. Even if the method suggests a transition of more than two tint regions, a tint command is sent to transition the window only a single tint region. If the ending tint region was dictated by control logic that relies on current outside conditions (e.g., clear sky and sunny, intermittent clouds, etc.), then the method locks out further transitions for a lockout period. During the lockout period, the control method monitors input about outside conditions and assesses what occurred (known historical data) during the wait time. Once exiting the lockout period, the method determines the current regime and a suggested tint region based on a statistical assessment of the conditions monitored during the lockout period. More details of these methods are described in the section below.

In the daytime regime, there are generally at least two threshold values and at least three tint regions. In the tail regimes, there is generally at least one threshold value and at least two tint regions. In certain examples described herein, the tail regime has one threshold value and two tint regions and the daytime regime has two threshold values and three tint regions. For example, the daytime regime may have two threshold values and a first tint region associated with a tint 2, a second tint region associated with a tint 3 and a third tint region associated with a tint 4 as determined by Modules AB (or more generally by a technique that does not rely on current exterior conditions). In this example, the tail regimes have one threshold value and a first tint region associated with a tint 2 and the third tint region associated with a tint 4. That is, the second tint region does not exist in the tail regimes.

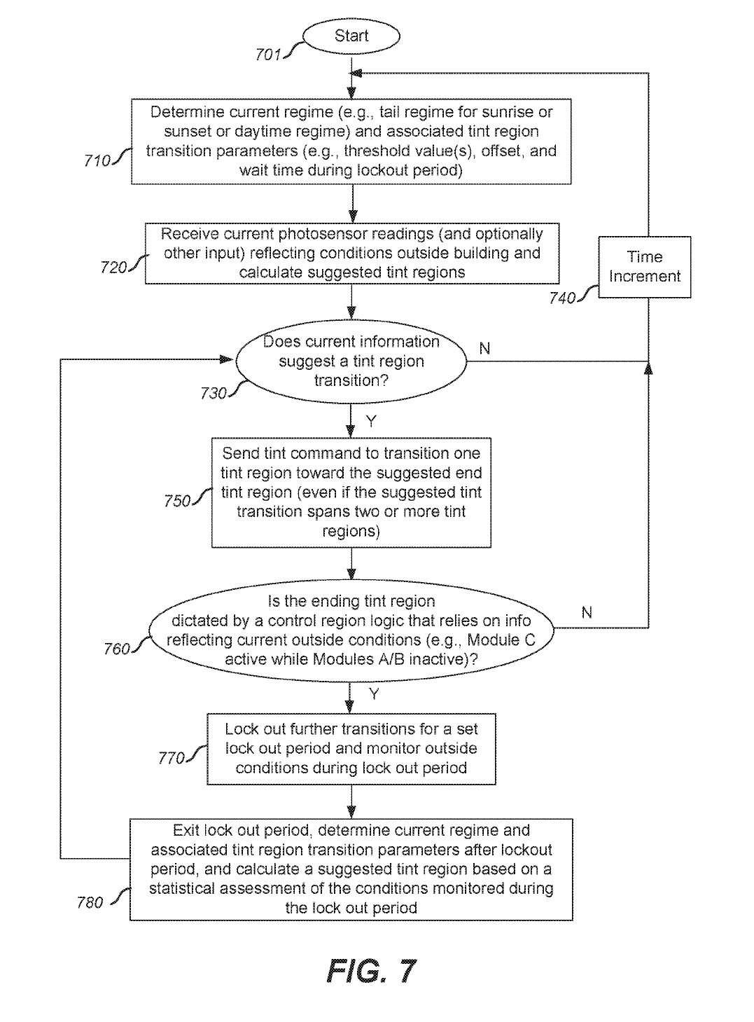

FIG. 11A and FIG. 11B include graphs of photosensor readings versus time over a day. The graph in FIG. 11B shows resulting tint levels based on tint decisions made with control logic with tail correction i.e. different threshold values in the tail regimes than in the daytime regime, typically with one less value. The graph in FIG. 11A shows resulting tint levels based on tint decisions made with control logic without tail correction i.e. threshold levels are the same in both the tail regimes and the daytime regime. In FIG. 11A, the graph shows a photosensor curve 1110, a single threshold level 1120 at 400, and the tint levels 1130. When the photosensor reading goes above the threshold level 1120 at about sunrise, the tint level 1130 goes up to a highest tint level and when the photosensor reading falls below the threshold value 1120 just before sunset, the tint level 1120 drops down to a lowest tint level. In FIG. 11A, the graph shows a photosensor curve 1140, a first threshold 1150 at a lower level and a second threshold value 1155 at a higher level in the daytime regime between tail regimes, and the tint levels 1160.

The lockout period (also called a “wait time”) refers a time during which no tint commands are made. During the wait time, the method makes tint calculations but does not send a tint command. The wait time works as a dampening mechanism to avoid rapid changes in transitioning. Different zones and/or different windows may have different wait times. The wait time is generally between 0 seconds and the transition time of the window or of a representative window in a zone of windows. In one example, the duration of the wait time is the transition time of the largest window in a zone.

In certain examples described herein, the control logic makes tinting decisions to transition to four tint levels (tint 1 also referred to as “T1,” tint 2 also referred to as “T2,” tint 3 also referred to as “T3,” tint 4 also referred to as “T4”). In one example, T1 corresponds to a transmissivity through a tintable window pane (lite) of about 50% (+/−10%), T2 corresponds to a transmissivity through a tintable window pane (lite) in a range of 25%-30% (+/−10%), T3 corresponds to a transmissivity through a tintable window pane (lite) of about 7% (+/−10%), T4 (darkest tint) corresponds to a transmissivity through a tintable window pane (lite) of about 1% (+/−10%). In some cases, the control logic uses the T3 corresponds to a transmissivity through a tintable window pane (lite) of about 7% when it determines that it is most probably intermediate cloud cover and high thin clouds.

In some cases, the control logic may implement one or more logic modules to determine the tint level in a tint region. For example, if a photosensor reading is above the highest threshold value indicating near clear sky conditions, logic modules A and B (or more generally, a module or modules that do not rely on currently determined outside conditions) may be used to determine the tint level. If the photosensor reading is below the highest threshold value indicating less than clear sky conditions, a logic module C (or more generally, a module or modules that rely on currently determined outside conditions) may be used to determine the tint level. Examples of logic modules A and B are described in International PCT Application PCT/US2015/029675, titled “CONTROL METHOD FOR TINTABLE WINDOWS,” filed on May 5, 2015, which is hereby incorporated by reference in its entirety. In some cases, module C uses certain operations of the module C described in PCT Patent Application PCT/US2015/029675. Examples of control logic can also be found in International PCT Application PCT/US16/41344, which is hereby incorporated by reference in its entirety.

According to certain examples, a logic module A can be used to determine a tint level that considers occupant comfort from direct sunlight passing through a tintable window onto an occupant or their activity area. The tint level is determined based on a calculated penetration depth of direct sunlight into the room and the space type (e.g., desk near window, lobby, etc.) in the room at a particular instant in time. Each space type is associated with different tint levels for occupant comfort. For example, if the activity is a critical activity such as work in an office being done at a desk or computer, and the desk is located near the window, the tint level determined by Module A may be higher than if the desk were further away from the window. As another example, if the activity is non-critical, such as the activity in a lobby, the tint level determined by Module A may be lower than for the same space having a desk. In some cases, the tint level may also be based on providing sufficient natural lighting into the room. The issue addressed in Module A is that direct sunlight may penetrate so deeply into a room as to shine directly on an occupant working at a desk or other activity area in a room. Publicly available programs can provide calculation of the sun's position and allow for calculation of penetration depth.

According to embodiments, Module B can be used to determine a tint level based on calculated values of solar irradiance under clear sky conditions flowing through the tintable window under consideration. Various software, such as open source RADIANCE program, can be used to calculate clear sky irradiance at a certain latitude, longitude, time of year, and time of day, and for a given window orientation.

Generally speaking, Module C makes tint decisions based on determinations from various inputs of one or more devices in the building system having the tintable window under consideration. Some examples of input devices that may provide input include, for example, visible light photosensors, infrared detectors, weather feed, etc.

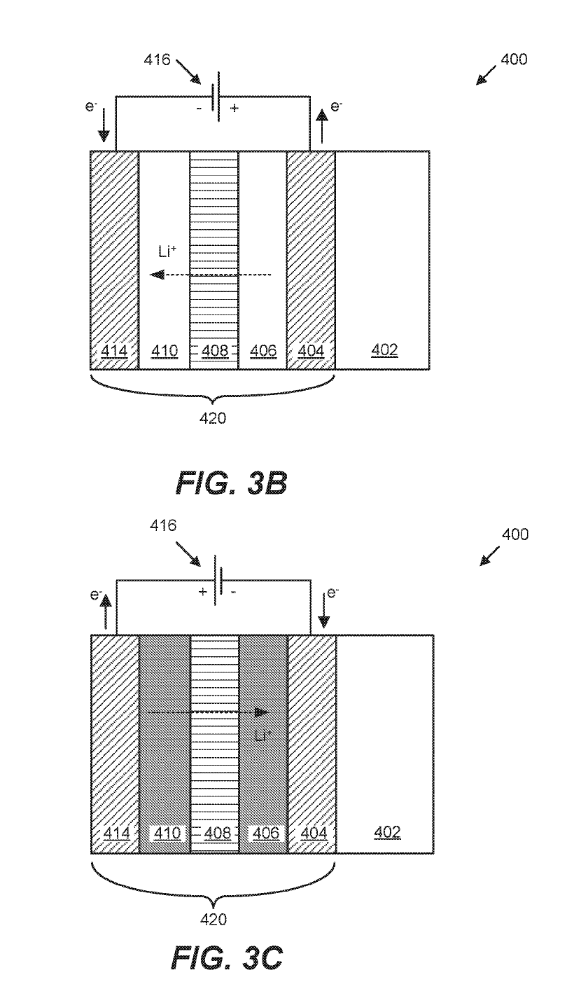

FIGS. 6A-6C include diagrams depicting some information collected by each of the three logic modules A, B, and C implemented by the exemplary control logic of disclosed embodiments. FIG. 6A shows the penetration depth at a particular instant in time of direct sunlight into a room 500 through an electrochromic window 505 between the exterior and the interior of a building, which includes the room 500. Penetration depth is a measure of how far direct sunlight will penetrate into the room 500. As shown, penetration depth is measured in a horizontal direction away from the sill (bottom) of window 505. Generally, the window defines an aperture that provides an acceptance angle for direct sunlight. The penetration depth is calculated based upon the geometry of the window (e.g., window dimensions), its position and orientation in the room, any fins or other exterior shading outside of the window, and the position of the sun (e.g. angle of direct sunlight for a particular time of day and date). Exterior shading to an electrochromic window 505 may be due to any type of structure that can shade the window such as an overhang, a fin, etc. In FIG. 6A, there is an overhang 520 above the electrochromic window 505 that blocks a portion of the direct sunlight entering the room 500 thus shortening the penetration depth. The room 500 also includes a local window controller 450 connected to and configured to control the tint level of the electrochromic window 505. An exterior sensor 510 is located on a vertical surface in the exterior of the building. FIG. 6A also shows a desk in the room 500 as an example of a space type associated with an activity area (i.e. desk) and location of the activity area (i.e. location of desk). Module A can be used to determine a tint level that considers occupant comfort from direct sunlight through the electrochromic window 505 onto an occupant or their activity area. For example, Module A can determine a tint level based on a calculated penetration depth of direct sunlight into the room 500 and the space type of a desk located (e.g., desk near window, lobby, etc.) in the room at a particular instant in time. In some cases, the tint level may also be based on providing sufficient natural lighting into the room.

FIG. 6B shows the room 500 of FIG. 6B at a particular instant in time where direct sunlight and solar radiation under clear sky conditions are entering the room 500 through the electrochromic window 505. The solar radiation may be from sunlight scattered by molecules and particles in the atmosphere. Module B can be used to determine a tint level based on calculated values of solar irradiance under clear sky conditions flowing through the electrochromic window 505 under consideration.

FIG. 6C shows the room 500 of FIGS. 6A and 6B with radiant light from the sky that can be obstructed by or reflected from objects such as buildings or weather conditions (e.g., clouds) that are not accounted for in the clear sky calculations of Module B.

In certain embodiments, the control logic may implement one or more of the logic Modules A, B and C to make tinting decisions for each electrochromic window (e.g., electrochromic window 505) in the building. Each electrochromic window can have a unique set of dimensions, orientation (e.g., vertical, horizontal, tilted at an angle), position, associated space type, etc. A configuration file with this information and other information can be maintained for each electrochromic window. The configuration file 475 (refer to FIG. 4) may be stored in the computer readable medium 470 of the local window controller 450 of the electrochromic window 505 or in the building management system (“BMS”). The configuration file 475 can include information such as a window configuration, an occupancy lookup table, information about an associated datum glass, and/or other data used by the control logic. The window configuration may include information such as the dimensions of the electrochromic window, the orientation of the electrochromic window, the position of the electrochromic window, etc.

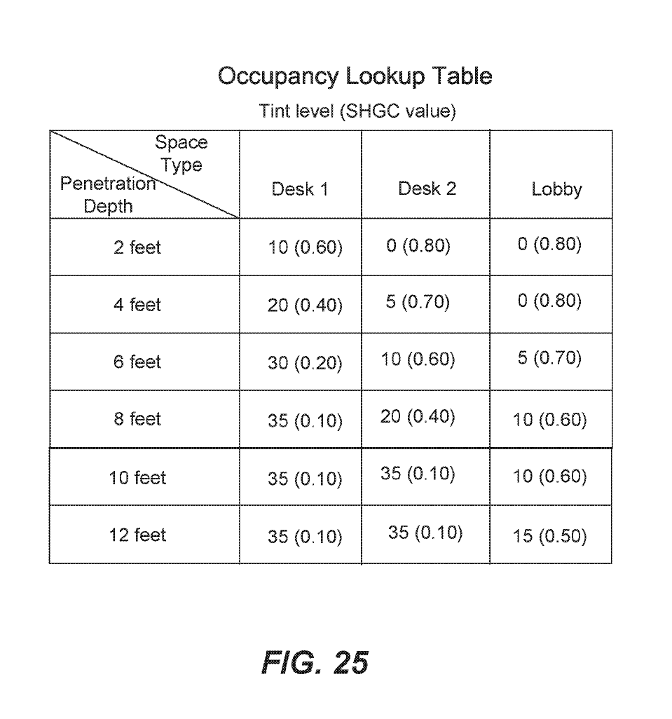

A lookup table describes different tint levels that provide occupant comfort for certain space types and penetration depths. That is, the tint levels in the occupancy lookup table are designed to provide comfort to occupant(s) that may be in the room from direct sunlight on the occupant(s) or their workspace. An example of an occupancy lookup table is shown in FIG. 25. The tint level in the table is in terms of Tᵥᵢₛ, (visible transmission). The table includes different tint levels (Tᵥᵢₛ values) for different combinations of calculated penetration depth values (2 feet, 4 feet, 8 feet, and 15 feet) for a particular space type and when the sun angle θ_{Sun} is between the acceptance angle of the window between θ₁=30 degrees and θ₂=120 degrees. The table is based on four tint levels including 4% (lightest), 20%, 40%, and 63%.

A space type is a measure to determine how much tinting will be required to address occupant comfort concerns for a given penetration depth and/or provide comfortable natural lighting in the room. The space type parameter may take into consideration many factors. Among these factors is the type of work or other activity being conducted in a particular room and the location of the activity. Close work associated with detailed study requiring great attention might be at one space type, while a lounge or a conference room might have a different space type. Additionally, the position of the desk or other work surface in the room with respect to the window is a consideration in defining the space type. For example, the space type may be associated with an office of a single occupant having a desk or other workspace located near a tintable window. As another example, the space type may be a lobby. In some cases, the space type may be part of the configuration file maintained by the building or stored in the local window controller. In some cases, the configuration file may be updated to account for various changes in the building. For example, if there is a change in the space type (e.g., desk moved in an office, addition of desk, lobby changed into office area, wall moved, etc.) in the building, an updated configuration file with a modified occupancy lookup table may be stored in the computer readable medium. As another example, if an occupant is hitting manual override repeatedly, then the configuration file may be updated to reflect the manual override.

IV. Exemplary Control Methods Implementing Intermediate Tint States

Certain aspects pertain to probabilistic control logic for methods of controlling one or more tintable windows, e.g., electrochromic windows, in a building. These control methods use a statistically probabilistic approach in making its tint decisions. Generally, the building system with one or more tintable windows has access to various types of input (e.g., photosensor readings, weather feed data, infrared readings, etc.) regarding the current outside conditions at the window. For example, a photosensor reading and/or weather feed data could be used to indicate a cloudy condition while an infrared reading may be useful for indicating a clear sky condition. The control methods statistically evaluate the input to determine the most statistically probable outside condition and use the probable outcome to make tint decisions. In this way, these control methods take a probabilistic approach to determining tint decisions based on a scenario of known information about the current conditions at the one or more tintable windows.

In some instances, this control method determines a confidence level for the most probable condition. If not that confident, more information (more inputs) may be used to determine the condition. In these instances, the control method may use a confidence matrix and/or another probabilistic approach to determine tint decisions based on the statistically best answer based on input from various devices. A confidence matrix maps the statistically best answer for various combinations of inputs. For example, where the photosensor reading and weather feed data indicate a cloudy condition while an infrared reading indicates a clear sky condition, the combination of inputs in the confidence matrix may output that it is most likely a cloudy condition.

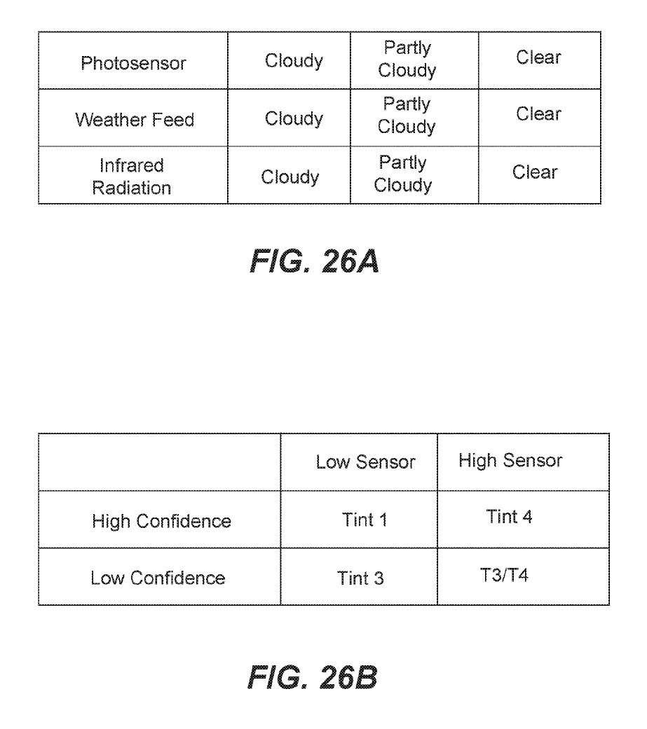

Different approaches can be used to determine the statistically probable best answer for various inputs from the various devices. In some cases all the input from the various devices is used to determine a statistically probable condition to use. In other cases, a set of one or more input is used. An example of a confidence matrix is shown in FIG. 26A. Another example of a confidence matrix is shown in FIG. 26B. In some cases, these probabilistic approaches are used to determine the most likely outcome during the lockout period.

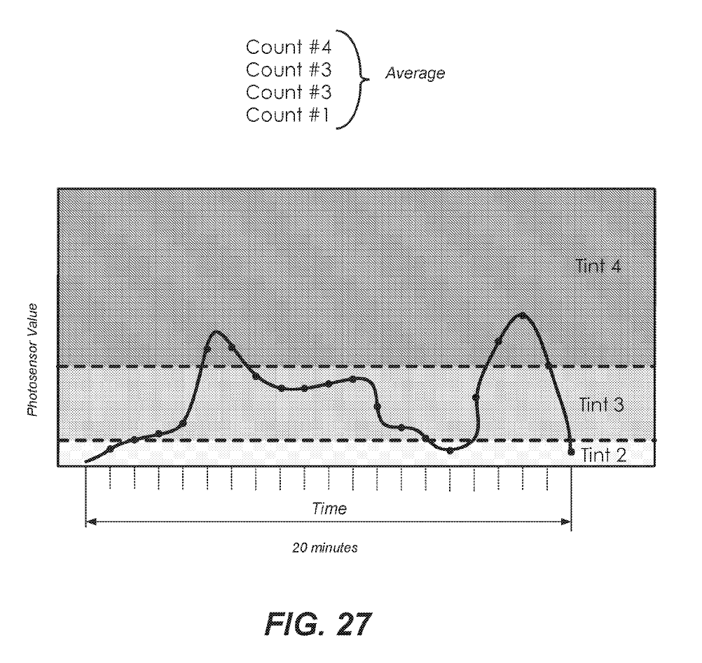

In some cases, during the wait time, the control method may populate a confidence matrix and determine the statistically probable best answer for inputs from various devices. For example, the control method may run a statistical analysis of one or more inputs to determine the confidence levels of difference tint decisions to populate confidence matrices during the lockout period. Some examples of types of statistical analysis of data that can be used to populate the confidence matrices include, for example, frequency analysis, trending the data, averaging the data, counting the data points, biasing through weighted averages, etc. To illustrate different ways of determining confidence in a tint decision, FIG. 27 shows sensor readings over a wait time of 20 minutes with a reading per minute.

In one example, the control method counts the number of sensor readings indicating a particular tint level during a wait period to determine the level of confidence in a particular tint level. In the illustrated example shown in FIG. 27, counting the number of sensor readings shows the Tint 3 has 11 counts, Tint 4 has 5 counts, and Tint 2 has 4 counts. Based on these counts, there would seem to be a high confidence in Tint 3.

In another example, the control method uses tint averaging of the tint levels determined over a wait period. The average may be a straight average, a mean, or a weighted average. A weighted average provides weights to particular tint levels. In one aspect, the control method uses biasing data through weighted averages taken over the wait period. For example, points closer to the current time can have a higher weight than points further away from the current time. In the illustrated example in FIG. 27, the straight average is 3.05 and the control logic would output Tint 3 based on the straight average.

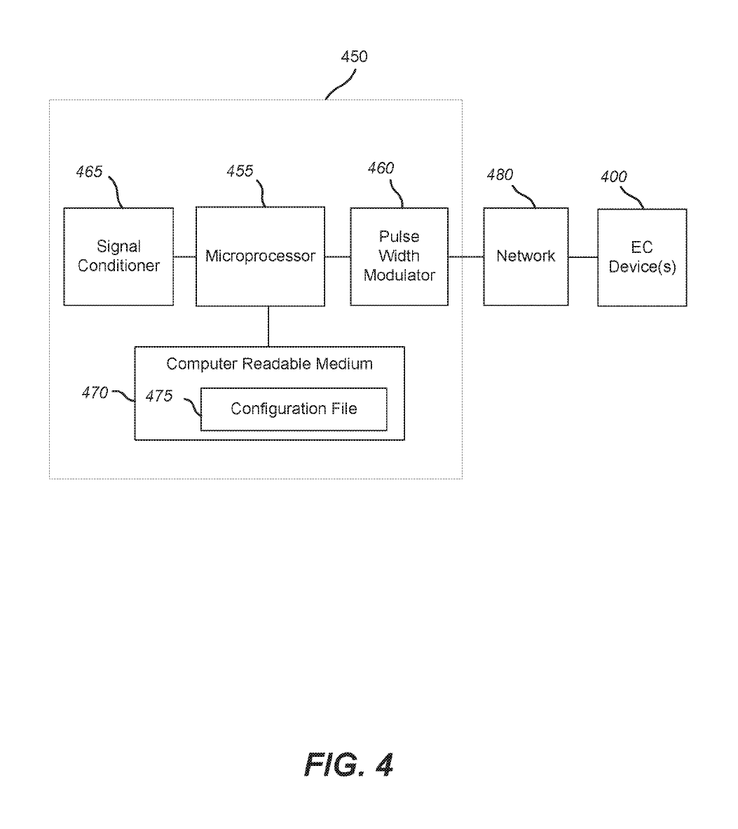

FIG. 7 is a flowchart showing control logic for a method of controlling one or more electrochromic windows in a building, according to embodiments. The control logic starts at operation 701 at a particular instant in time that is not during a lockout period and not at nighttime before sunrise and after sunset. In one aspect, the control logic may implement nighttime logic if the instant in time is during a nighttime regime such as, for example, control logic based on building security and other considerations.

At operation 710, the control logic implements an operation that determines the current regime (e.g., tail regime or daytime regime) at the particular instant in time and determines the associated tint region transition parameters such as, for example, threshold value or values, predefined tail regime offsets, and wait time during a lockout period. The operation determines whether or not the instant in time is in a tail regime and if not in the tail regime, it is determined that the instant in time is in a daytime regime. The control logic can take various approaches to determine whether this instant in time is in a tail regime.

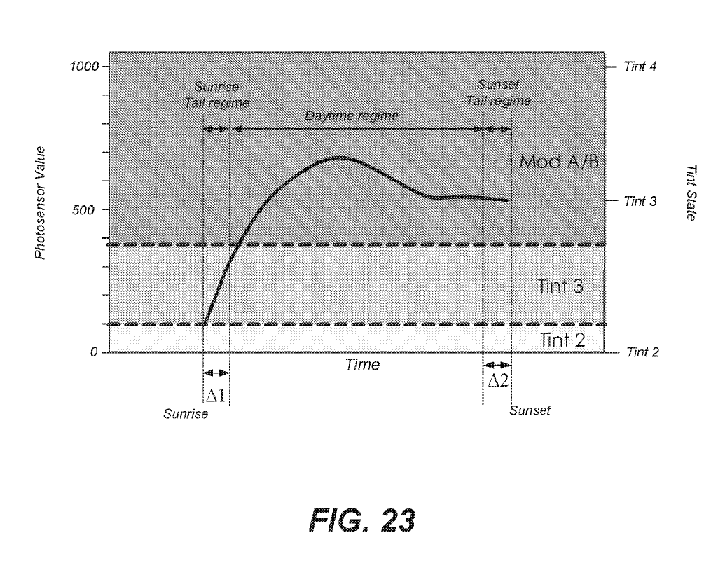

In one approach, tail regimes are based on predefined offsets from the time at sunset and sunrise during that day. That is, the first sunrise tail regime starts at sunrise and extends a first predefined offset after sunrise and the sunset tail regime ends at sunset and starts at a second predefined offset before sunset. The first and second predefined offsets generally have the same or similar duration of time. The daytime regime extends after the sunrise tail regime and before the sunset tail regime. When using this approach, the control logic determines whether the current instant in time is within the predefined offset from sunset/sunrise or during the daytime regime. FIG. 23 shows an example of a photosensor curve with tail regimes defined by a first predefined offset, Δ1 and a second predefined offset, Δ2.

Another approach to determining whether an instant in time is in a tail regime or in a daytime regime involves evaluating the smoothness or discontinuity, oscillating frequency, and/or slope of the sensor curve to determine whether the readings indicate that the instant in time is in a tail regime. FIG. 24 shows examples of photosensor curves for a partly cloudy condition, a cloudy condition, and a sunny condition, according to an embodiment. As shown, during a partly cloudy condition sensor readings generally fluctuate widely (high frequency of oscillation) between low and high sensor readings. During a cloudy condition sensor readings generally fluctuate between relatively low readings (lower frequency of oscillation and generally low value flat slope). During a sunny condition, the slope is steep and there is generally little to no oscillation. When using this approach, the control logic determines whether the instant in time is in a daytime regime or in a tail regime based on one or more of oscillation frequency, oscillation magnitude, slope and other characteristics of the photosensor curve. For example, the control logic evaluates one or more of these characteristics of the photosensor curve to determine whether the instant in time is a tail regime i.e. where daytime thresholding is not as effective. In one case, the control logic determines whether the sensor readings suggest a partly cloudy condition, cloudy condition or a sunny condition. In one aspect, if the control logic determine the sensor readings suggest a cloudy condition or a partly cloudy condition, the control logic determines the instant in time is in a tail regime. If the control logic determines a sunny condition based on the readings, the control logic determines the instant in time is in a daytime region. In another aspect, if the control logic determines the readings indicate a cloudy condition, the control logic determines the instant in time is in a tail regime. If the control logic determines the readings indicate a party cloudy or sunny condition, the instant in time is determined to be in a daytime region. In the daytime regime, the control logic generally has at least two threshold values and at least three tint regions. In the tail regimes, the control logic generally has at least one threshold value and at least two tint regions.

At operation 720, current photosensor readings (and optionally other input) are received reflecting conditions outside the building. This thresholding operation calculates the suggested tint region by determining whether the current sensor reading (and optionally other input) crossed one or more threshold values over a period of time, for example, between the current time and the last reading or between the current time and a multiple readings previously taken. Readings may be taken on a periodic basis such as once a minute, once every 10 seconds, once every 10 minutes, etc. The threshold values are determined in operation 710 based on the current regime.

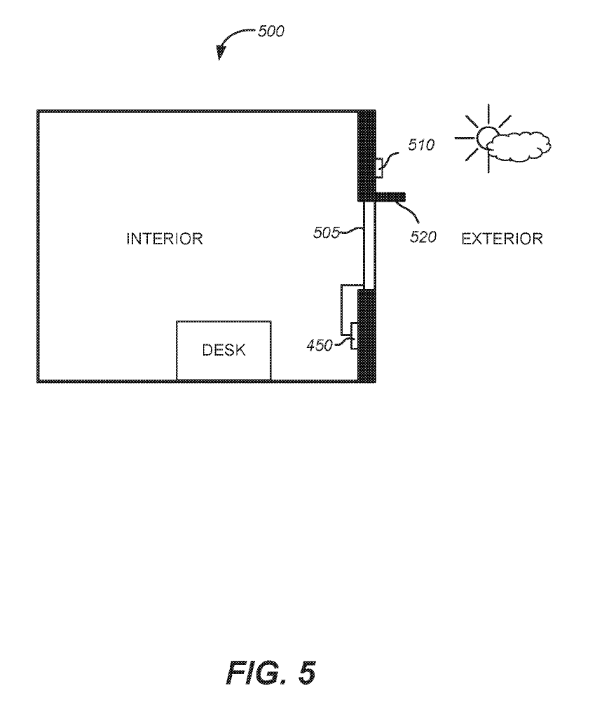

An example of a thresholding operation is described with reference to the graph shown in FIG. 8 of photosensor readings versus time. In this example, there are three tint regions: a first tint region 820, a second tint region 830, and a third tint region 840; and two threshold values to determine the tint region boundaries: a first threshold value 850 and a second threshold value 860. In this example, if the operation determines that the photosensor readings are below the first threshold value 850 in the first tint region 820, the operation suggests tint 2. If the operation determines that the photosensor readings are above the first threshold value 850 and below the second threshold value 860 in the second tint region 830, the operation suggests tint 3. Above the second threshold value 850 in the third tint region 840, the operation suggests using a module A and/or module B to determine the tint level. A photosensor curve 870 is also shown. As shown, from 12 AM to about 7:45 AM, the values of the photosensor curve 870 are below the first threshold value 850 in the first tint region 820 and the operation suggests tint 2. At some time after 8:00a.m. near sunrise, the values of the photosensor curve rise above the first threshold value 850 in the second tint region 830 and the operation suggests using tint 3. At some time shortly after sunrise at about 8:30, the value of the photosensor curve goes above the second threshold value 860 in the third tint region 840 and the operation suggests using module A and/or module B to determine the suggested tint level. At some time shortly before sunset at about 5:30 PM, the value of the photosensor curve goes below the second threshold value 860 in the second tint region 830 and the operation suggests using tint 3. After sunset, the photosensor values go below the first threshold value 850 in the first tint region 820 and the operation suggests using tint 2.

Returning to FIG. 7, operation 730 goes on to determine whether the current information suggests a tint region transition. This operation 730 determines whether the suggested tint region determined from operation 720 is different than the current tint region being used in the window. If a tint transition is not suggested, the method uses a timer to increment to the next interval for the logic calculations at operation 740 and returns to operation 710. In some cases, the time intervals may be constant. In one case, the logic calculations are done every 2 to 5 minutes. If a tint transition is suggested at operation 730, the method continues to operation 750.

At operation 750, a tint command is sent, for example to a window controller, to start a transition of the tintable window one tint region toward the suggested tint region determined in operation 720. Even if the transition to the suggested tint region determined in operation 720 spans two or more tint regions, the tint command sent is only to start transition of a single tint region. For example, if the suggested tint region determined in operation 720 is from a first tint region to a third tint region, the tint command sent is to transition one tint region to a second tint region.

In some cases, the tint command to transition one tint region toward the suggested tint region will start a transition to a tint level associated with the end tint region. For example, the first tint region may correspond to tint 2 and the second tint region may correspond to tint 3. In other cases, the tint command to transition one tint region toward the suggested tint region will start a transition to a tint level determined by one or more logic modules such as modules A, B, and C introduced above. For example, the upper tint region associated with higher irradiance levels may correspond to a tint level determined by modules A and B.

At operation 760, it is determined whether the end tint region from operation 750 is determined based on information reflecting current outside conditions. For example, if the outside conditions are clear sky and sunny, modules A and B may be active and determining the tint level of the ending tint region. In this case, the tint level determined by modules AB is not based on current outside conditions. If not based on information reflecting current outside conditions, the method uses a timer to increment to the next interval for the logic calculations at operation 740 and returns to operation 710. If the tint level is based on information reflecting current outside conditions, the method continues on to operation 770. For example, if the tint level is based on current outside conditions such as a cloudy condition, then Module C is active and determining the tint level used in the ending tint region.

At operation 770, there is a lock out from further transitions to other tint regions for a set lockout period. During this lockout period, outside conditions are monitored. At the end of the lockout period at operation 780, the current regime at the instant in time after the lockout period and associated transition parameters is determined. For example, the control logic may determine whether the instant in time is within a tail regime or a daytime regime. If at nighttime, the control logic may implement nighttime logic. In addition, the control logic calculates a suggested tint region based on the conditions monitored during the lockout period. The method then continues to operation 730 to determine whether the current information suggests transition.

At operation 780, the suggested tint region calculated based on the conditions monitored during the lockout period is based on a statistical evaluation of the monitored input. Various techniques can be used for the statistical evaluation of the input monitored during the wait time. One example is tint averaging during the wait time. During the wait time, the control logic implements an operation that monitors the input and calculates tint levels determined, for example, using one or more of modules A, B and C. The operation then averages the determined tint levels over the wait time to determine which direction is suggested for a one tint region transition.

FIG. 9 depicts a graph illustrating tinting decisions of control logic implementing a method that uses tint averaging over the wait time 910 to control a tintable window, according to an embodiment. In this example, tint averaging is used to determine a suggested tint region transition after the wait time based on averaging tint decisions that are made based on input monitored during the wait time 910. The photosensor curve 970 of the photosensor values and the current tint state 980 determined by the method are shown. At position 1, the control logic transitions the tint of a window to T3 based on calculations made by modules AB in the upper tint region. The operation then goes into a wait time 910 during which no commands for transitioning are sent. During the lockout, the tint averaging operation continues to monitor photosensor readings and to calculate tint levels determined using modules A, B and/or C. As shown, the tint levels T3, T4, T2, T3, and T4 are determined at five time intervals during the wait time. Based on these five calculated tint levels, the average tint level during the wait time is Tint 3.2. Since the average tint level calculated during the lockout period is Tint 3.2, the probabilistic control logic determines that the current information does not suggest a tint region transition and the tint level remains at T3.

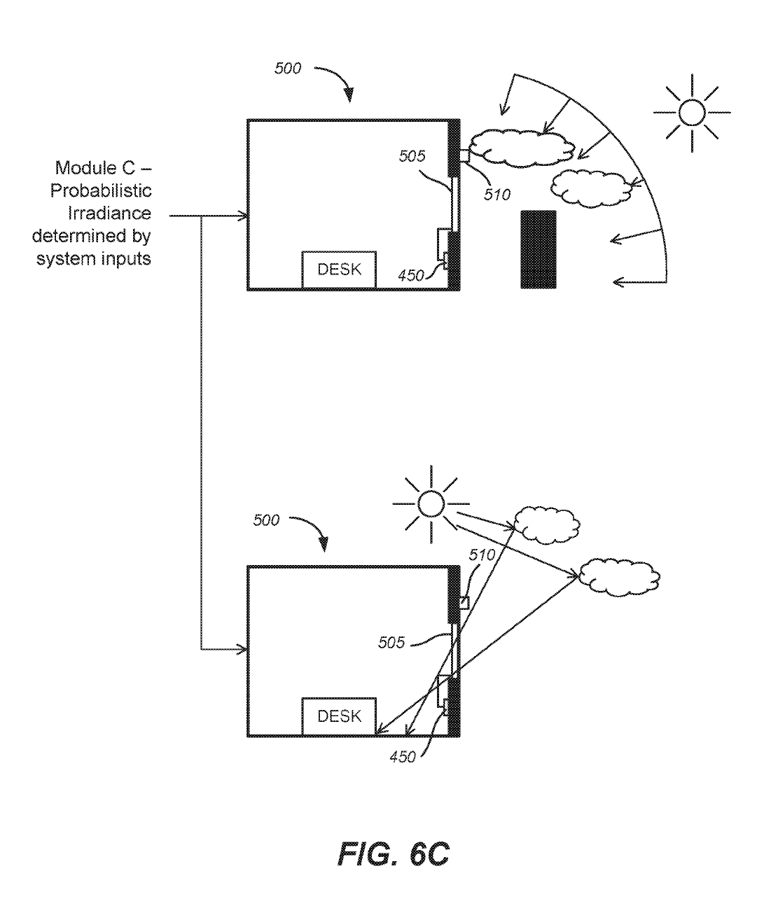

FIG. 10 depicts a graph illustrating tinting decisions of control logic implementing a method for controlling a tintable window, according to an embodiment. The photosensor curve 1070 of the photosensor values and the current tint state 1080 determined by the method are shown. In this example, there is a first threshold value 1052 and a second threshold value 1054 and a first tint region 1020 below the first threshold value 1052, a second tint region 1040 between the first threshold value 1052 and the second threshold value 1054, and a third tint region 1050 above the second threshold value 1054. This method only allows one tint region transition per calculation. When transitioning in/out of a tint region, the method waits a definable lockout period of time 1010 before initiating another transition. At position 1, the method uses modules A, B and/or C to calculate Tint 2. At position 2, the method uses modules A, B and/or C to calculate Tint 3. Because there was a transition between Tint 2 and Tint 3 at position 2, the method waits a definable lockout period of time (X) 1010 at Tint 3. At position 3, the method uses modules A, B and/or C to calculate Tint 4. At position 4, the method uses modules A, B and/or C to calculate Tint 2. Because the calculation at position 4 crosses two tint regions, the method chooses to transition one tint region to Tint 3 and waits a definable lockout period of time 1010. After the lockout period, the method uses modules A/B to calculate Tint 3. At position 4, the method uses modules A/B to calculate Tint 4 and the logic transitions to Tint 4 and waits a definable lockout period of time 1010.

In one example, the parameters include a first threshold value and a second threshold value that is larger than the first threshold value. The parameters also include a morning offset, an evening offset, and a predefined wait time during the lockout period. For morning/evening performance in the tail regimes, if the photosensor reading is below the first threshold, the control method goes to tint 2 and otherwise goes to tint 4. For midday performance in the daytime regime, if the photosensor readings jump from one tint region to the next adjacent tint region, the method waits a predefined time during the lockout period and takes the average tint states to determine whether a new transition is suggested. If this photosensor reading crosses multiple tint regions, the method goes to the adjacent tint region and waits a predefined time during a lockout period. The method takes the average tint states to determine whether a new transition is suggested.

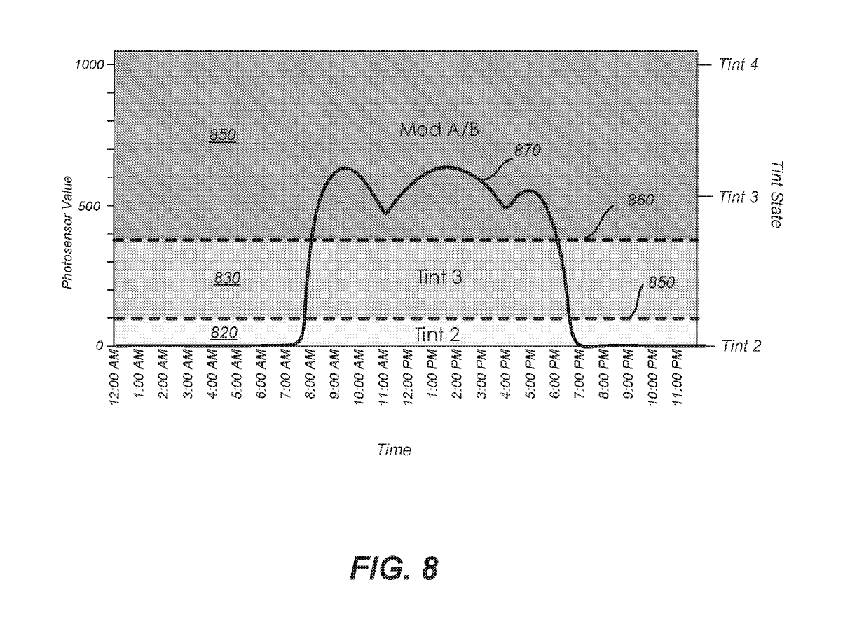

FIGS. 12A, 12B, and 12C depict three graphs illustrating the performance of a method implemented by control logic in a sunny condition, intermittent cloud cover condition, and cloudy to sunny condition respectively, according to an embodiment. The control logic uses parameters comprising a first threshold=100, a second threshold=400, a morning offset=1 hour, and evening offset=1 hour, and a wait time=0 (i.e., no wait time). The sunny day condition does not show Tint 3 in the tail regimes. The intermediate cloud cover condition tends to stay at Tint 3. The method biases to Tint 4 in the tail regimes which might be perceived as tail tinting during intermediate cloud cover.

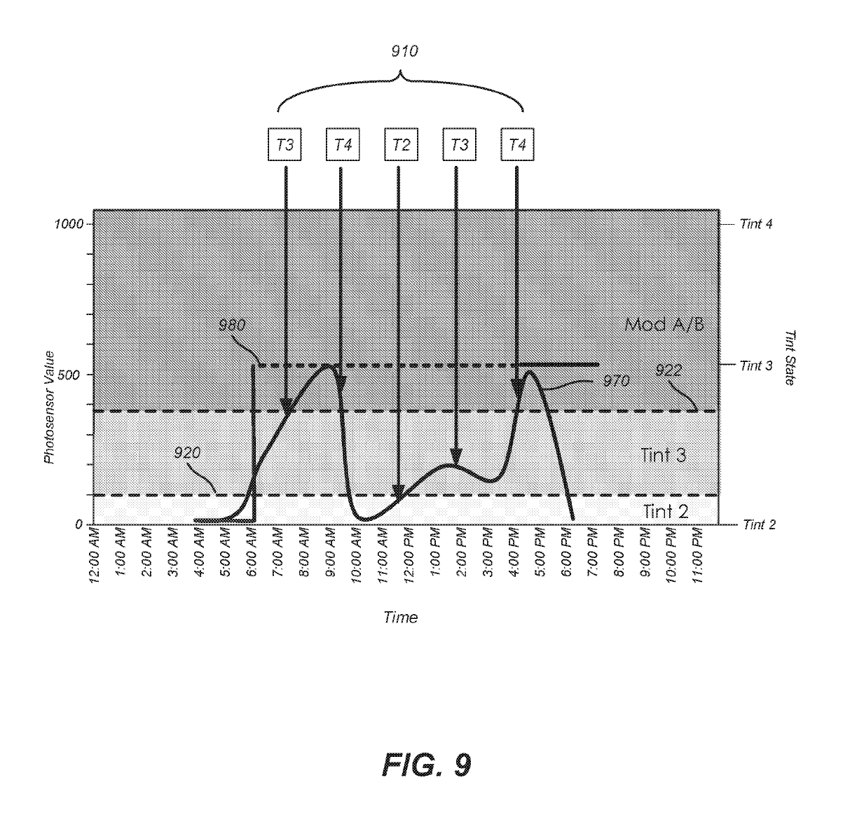

FIGS. 13A, 13B, and 13C depict three graphs illustrating the performance of a method implemented by control logic in a sunny condition, intermittent cloud cover condition, and cloudy to sunny condition, according to an embodiment. The control logic uses parameters comprising a first threshold=100, a second threshold=400, a morning offset=1 hour, and evening offset=1 hour, and a wait time=45 minutes. The sunny day condition does not show Tint 3 in the tail regimes.

In various embodiments, the control logic implements a method that does not allow more than one tint region transition at a particular time. In the case that the lower tint region is T1 and the adjacent upper tint region is T3, this may still be considered a one tint region jump. In the case that the lower region is Tint 1 and the adjacent upper region is an A/B region, jumping to the higher A/B region (that determines Tint 4) is still considered a one tint region jump. During a lockout period, the method may use module C to determine the tint state of the initial tint command and then continue to calculate module C values. This determines if to jump back to Module A/B (represented by T4 in averaging) to stay at the current tint region, or to proceed to a lighter tint state. The module C initial tint command or the final tint state command cannot exceed module A/B constraints. During the lockout period, the method sends two tint commands. The first tint command is when module C becomes active (i.e. the method went from Tint 4 to module C driven Tint 3). The last tint command is after module C decides to move back to the tint region Module A/B, stay at the current tint state, or jump to the next lowest tint region. All other calculations are done by module C to determine direction.

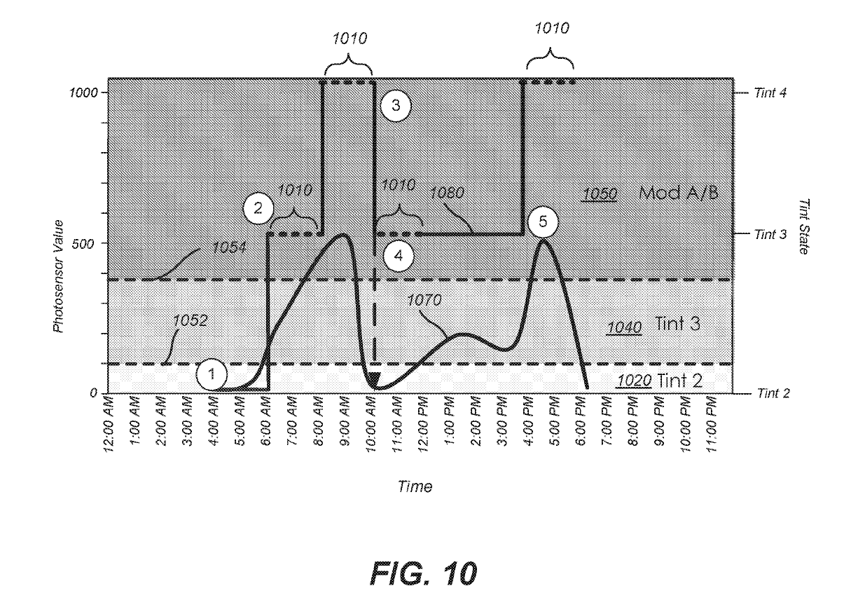

FIG. 14 depicts a graph illustrating the performance of a method implemented by control logic, according to an embodiment. The graph includes a photosensor curve 1470 and the tint level curve 1480 of the executed tint commands during a first condition. The tint level curve 1480 includes a lockout period 1410. In this example, there is a first threshold value 1490 and a second threshold value 1491, a first tint region below the first threshold value 1490, a second tint region between the first threshold value 1490 the second threshold value 1491, and a third tint region above the second threshold value 1491. When the photosensor values in photosensor curve 1470 are greater than second (upper) threshold value 1491, Module A/B outputs Tint 4 and the system is not in a lockout condition. When the control logic determines tint change to Tint 3 based on photosensor values dropping below second threshold value 1491, the control logic starts a lockout period 1410 during which tint state is held at Tint 3 until the end of the lockout period 1410. During the lockout period 1410, Module C continues to output Tint 3 for the duration averaging Tint 3 during the lockout period. At the end of the lockout period 1410, the photosensor values of photosensor curve 1470 are still in the Tint 3 range. After the lockout period 1410, the control logic will continue to output Tint 3 with no lockout until a tint command change.

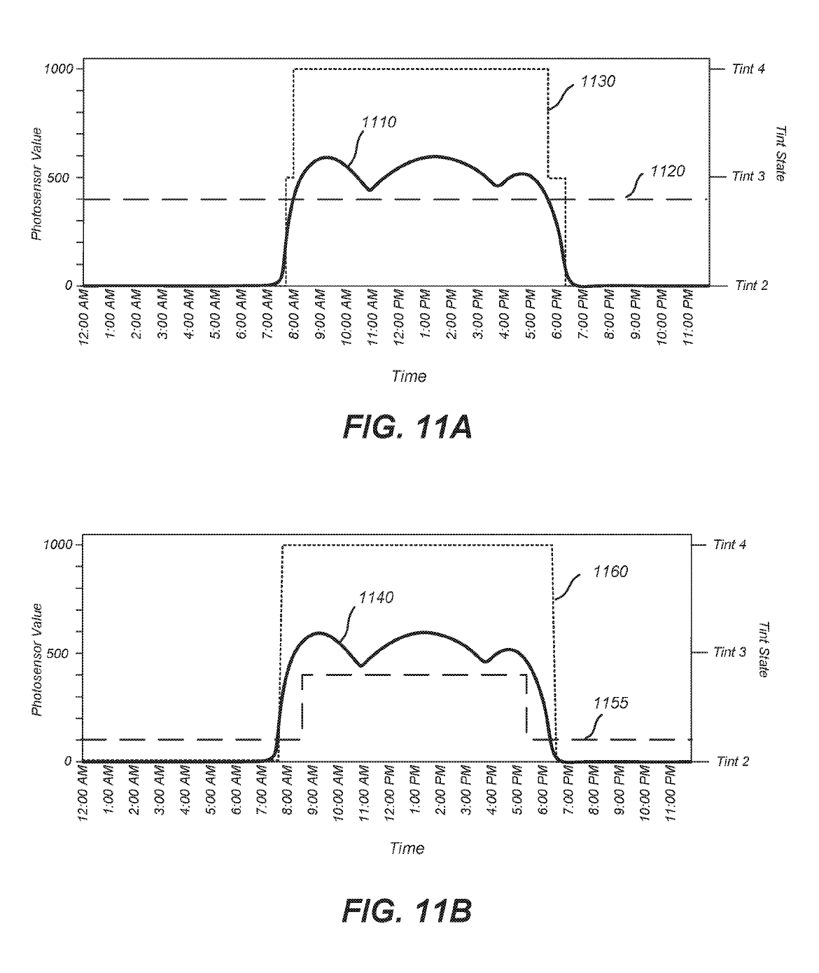

FIG. 15 depicts a graph illustrating the performance of a method implemented by control logic, according to an embodiment. The graph includes a photosensor curve 1570 and the tint level curve 1580 of the executed tint commands a second condition. The tint level curve 1580 includes a first lockout period 1510 and a second lockout period 1511. In this example, there is a first threshold value 1590 and a second threshold value 1591, a first tint region below the first threshold value 1590, a second tint region between the first threshold value 1590 and the second threshold value 1591, and a third tint region below the second threshold value 1591. When the photosensor values in photosensor curve 1570 are greater than second (upper) threshold value 1591, Module A/B outputs Tint 4 and the system is not in a lockout condition. When the control logic determines tint change to Tint 3 based on photosensor values dropping below second threshold value 1591 at about 9 AM, the control logic starts a first lockout period 1510 during which tint state is held at Tint 3 until the end of the lockout period 1510. During the lockout period 1510, Module C calculates mostly Tint 2 averaging Tint 2 during the first lockout period 1510. At the end of the lockout period 1510, the photosensor values of photosensor curve 1570 are in the first tint region. The control logic outputs Tint 2 and resets for a second lockout period 1511 and holds at Tint 2 until the end of the second lockout period 1511. At the end of the second lockout period 1511, the photosensor values of photosensor curve 1570 are still in the first tint region and the control logic calculates Tint 2.

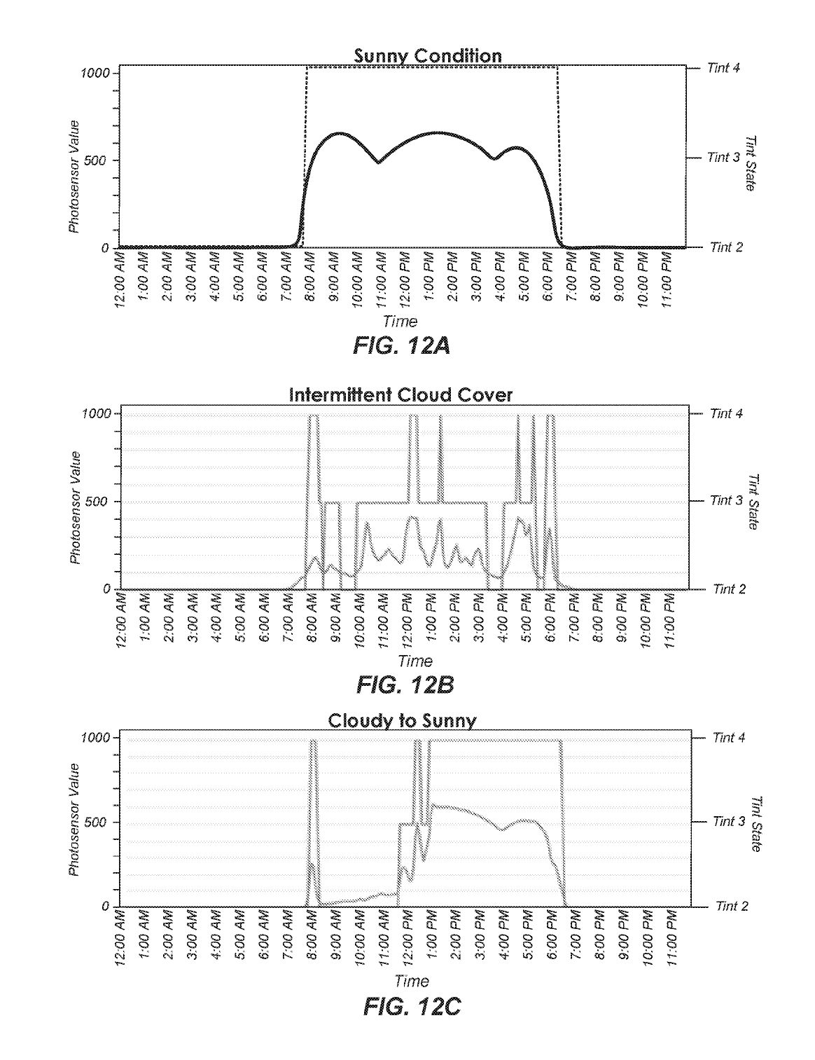

FIG. 16 depicts a graph illustrating the performance of a method implemented by control logic, according to an embodiment. The graph includes a photosensor curve 1691 and the tint level curve 1680 of the executed tint commands a third condition. The tint level curve 1680 includes a lockout period 1610. In this example, there is a first threshold value 1690 and a second threshold value 1691, a first tint region below the first threshold value 1690, a second tint region between the first threshold value 1690 and the second threshold value 1691, and a third tint region above the second threshold value 1691. When the photosensor values in photosensor curve 1670 are greater than second (upper) threshold value 1691, Module A/B outputs Tint 4 and the system is not in a lockout condition. At about 9 AM, the photosensor values drop below the first threshold value 1690. The control logic determines that only one tint level change is allowed and determines Tint 3 and starts a lockout period 1610. The tint state will be held at Tint 3 until the end of the lockout period 1610. During the lockout period, Module C calculates mostly Tint 4 and the average tint level is about 3.5. At the end of the lockout period 1510, Module A/B determines Tint 4. Another lockout period will not be initiated while Module A/B is determining tint state.

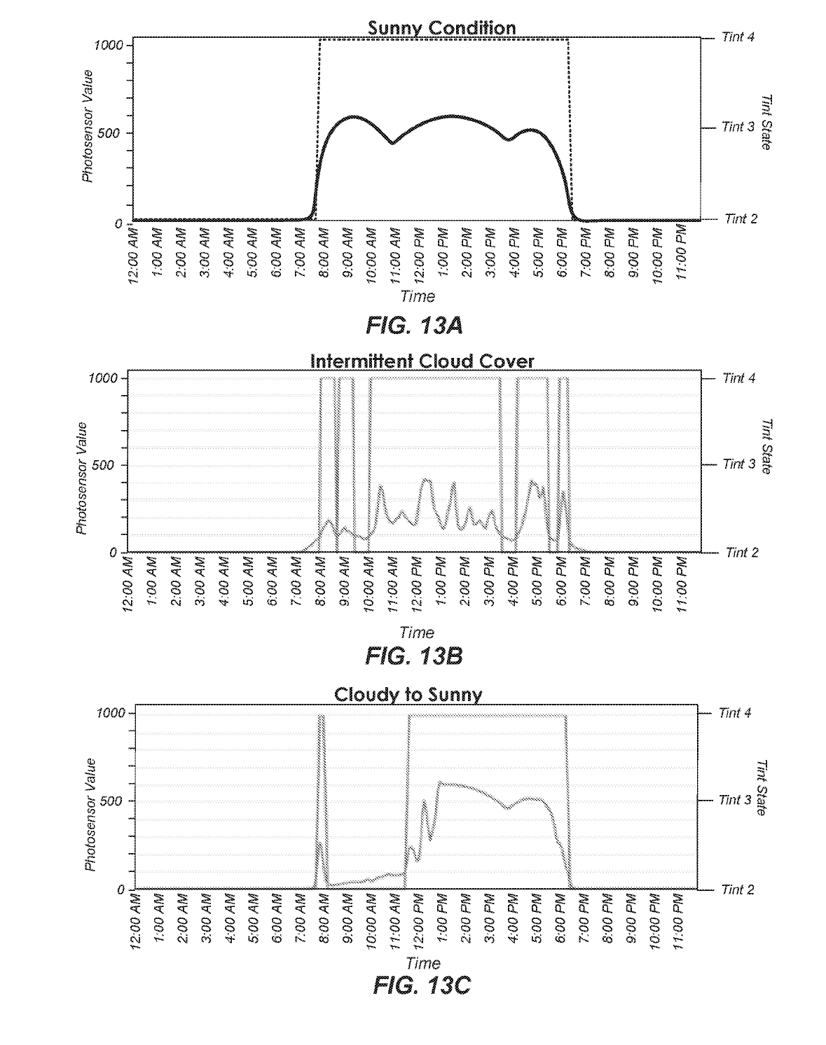

FIG. 17 depicts a graph illustrating the performance of a method implemented by control logic, according to an embodiment. The graph includes a photosensor curve 1770 and the tint level curve 1780 of the executed tint commands during a fourth condition. The tint level curve 1780 includes a lockout period 1710. In this example, there is a first threshold value 1790 and a second threshold value 1791, a first tint region below the first threshold value 1790, a second tint region between the first threshold value 1790 and the second threshold value 1791, and a third tint region above the second threshold value 1791. When the photosensor values in photosensor curve 1770 are greater than second (upper) threshold value 1791, Module A/B outputs Tint 4 and the system is not in a lockout condition. At about 9 AM, the photosensor values drop into the first tint region. The control logic determines that only one tint level change is allowed and determines Tint 3 and starts a lockout period 1710. The tint state will be held at Tint 3 until the end of the lockout period 1710. During the lockout period, Module C calculates mostly Tint 4 and the average tint level is about 3.5. At the end of the lockout period 1710, the control logic exits Module C and uses Module A/B to determine Tint 2. Another lockout period will not be initiated while Module A/B is determining tint state.

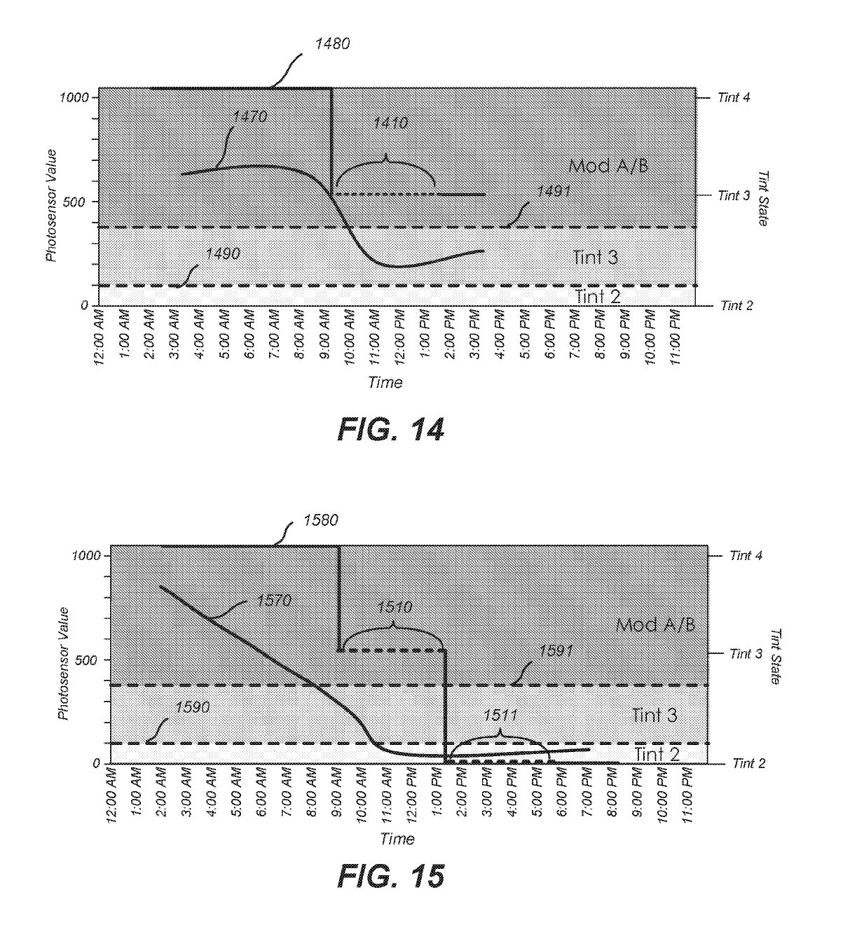

FIG. 18 depicts a graph illustrating the performance of a method implemented by control logic, according to an embodiment. The graph includes a photosensor curve 1870 and the tint level curve 1880 of the executed tint commands during a fifth condition. The tint level curve 1880 includes a lockout period 1810. In this example, there is a first threshold value 1890 and a second threshold value 1891, a first tint region below the first threshold value 1890, a second tint region between the first threshold value 1890 and the second threshold value 1891, and a third tint region above the second threshold value 1891. From 2:00 AM until just before 9:00 AM, the photosensor values are less than the first threshold value 1890 and the control logic determines Tint 2. During this time period, the system is not in a lockout condition and is in a steady state Tint 2. At about 9 AM, the photosensor values rise from the first tint region into the third tint region. The control logic determines that only one tint level change is allowed and determines Tint 3 and starts a lockout period 1810. The tint state is held at Tint 3 until the end of the lockout period 1810. During the lockout period, Module C calculates mostly Tint 4 and the average tint level is about 3.5. At the end of the lockout period 1810, the control logic exits Module C and uses Module A/B to determine Tint 4. Another lockout period will not be initiated while Module A/B is determining tint state.

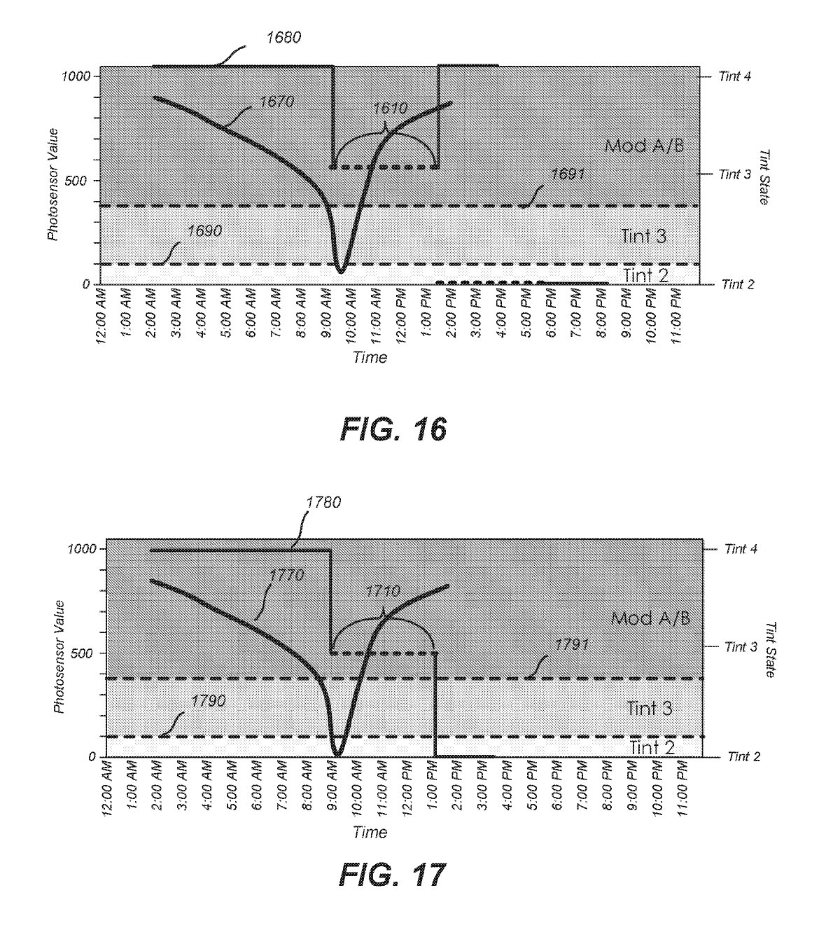

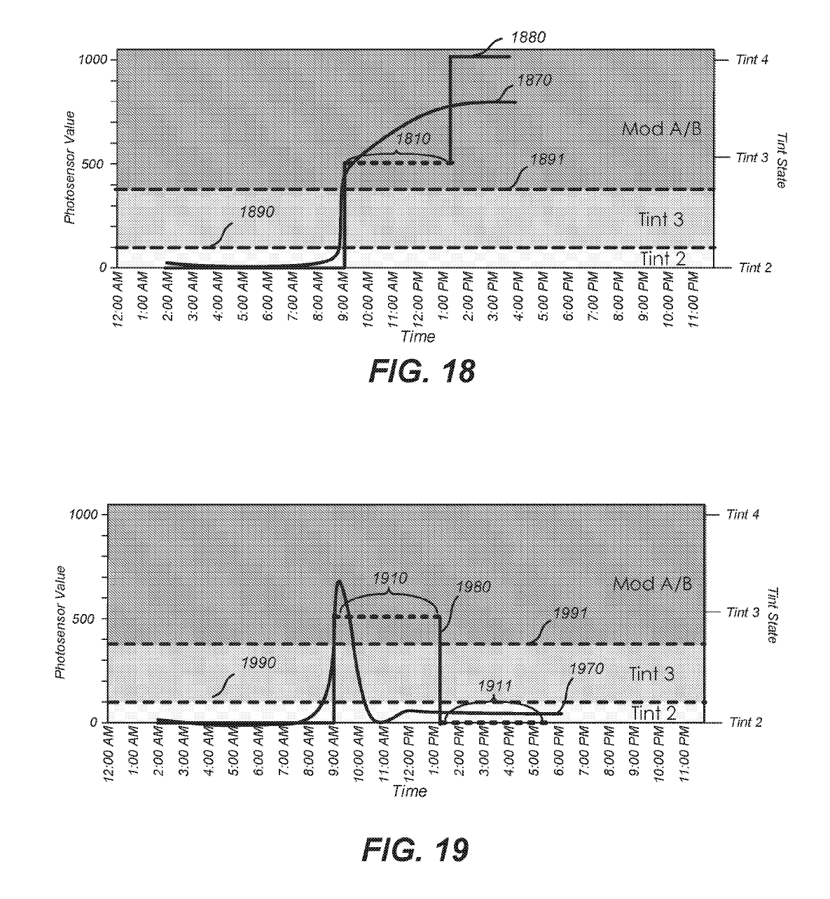

FIG. 19 depicts a graph illustrating the performance of a method implemented by control logic, according to an embodiment. The graph includes a photosensor curve 1970 and the tint level curve 1980 of the executed tint commands during a sixth condition. The tint level curve 1980 includes a first lockout period 1910 and a second lockout period 1911. In this example, there is a first threshold value 1990 and a second threshold value 1991, a first tint region below the first threshold value 1990, a second tint region between the first threshold value 1990 and the second threshold value 1991, and a third tint region above the second threshold value 1991. From 2:00 AM until just before 9:00 AM, the photosensor values are less than the first threshold value 1990 and the control logic determines Tint 2. During this time period, the system is not in a lockout condition and is in a steady state Tint 2. At about 9 AM, the photosensor values rise from the first tint region into the third tint region. The control logic determines that only one tint level change is allowed and determines Tint 3 and starts a first lockout period 1910. The tint state is held at Tint 3 until the end of the first lockout period 1910. During the lockout period, Module C calculates mostly Tint 2. At the end of the first lockout period 1910, the photosensor values is below the first threshold value. The control logic uses Module C to calculate Tint 2 and resets a second lockout period 1911 and holds at Tint 2 until the end of the second lockout period 1911. FIG. 20 depicts a graph illustrating the performance of a method implemented by control logic, according to an embodiment. The graph includes a photosensor curve 2070 and the tint level curve 2080 of the executed tint commands during a sixth condition. The tint level curve 2080 includes a lockout period 2010. In this example, there is a first threshold value 2090 and a second threshold value 2091, a first tint region below the first threshold value 2090, a second tint region 2091 between the first threshold value 2090 and the second threshold value 2091, and a third tint region above the second threshold value 2091. From 2:00 AM until just before 9:00 AM, the photosensor values are less than the first threshold value 1990 and the control logic determines Tint 2. During this time period, the system is not in a lockout condition and is in a steady state Tint 2. At about 9 AM, the photosensor values rise from the first tint region into the third tint region. The control logic determines that only one tint level change is allowed and determines Tint 3 and starts a lockout period 2010. During the lockout period, Module C calculates Tint 3. At the end of the lockout period, since the photosensor values are in the second tint region and the average tint value during the lockout period was Tint 3, the control logic determines Tint 3. When the photosensor values move into the third tint region, control logic exits Module C and uses Module A/B to determine Tint 4. Another lockout period will not be initiated while Module A/B is determining tint state.

In some embodiments, the control logic discussed with reference to FIG. 7 and other examples can be implemented to control one or more tintable windows in an entire building on a single master window controller. In other examples, the control logic can be implemented in a window controller controlling a single window or a zone of windows. In another example, the control logic can be implemented on a window controller to control tint levels for one or more tinting zones in a multi-zone window. Some examples of multi-zone windows can be found in PCT application No. PCT/US14/71314 titled “MULTI-ZONE EC WINDOWS,” which is hereby incorporated by reference for the discussion of multi-zone windows.

Also, there may be certain adaptive components of the control logic of embodiments. For example, the control logic may determine how an end user (e.g. occupant) tries to override the algorithm at particular times of day and makes use of this information in a more probabilistic manner to determine desired tint levels. In one case, the end user may be using a wall switch or remote device to override the tint level provided by the logic at a certain time each day to an override value. The control logic may receive information about these instances and change the control logic to change the tint level to the override value at that time of day.

In certain embodiments, the control logic implements a control method that issues tint commands that will only send a tint command to transition the window one tint region at a time even if the control modules suggest tint transition that spans two or more regions. If the ending tint region was determined based on current outside conditions (i.e. Module C controlling), then the control method is locked out for a wait time. During the lockout period, module C continues calculating Module C values. At the end of the lock out period, these Module C Values are used to determine whether to transition to higher new tint region, stay in current tint region, or proceed to a lighter tint region.

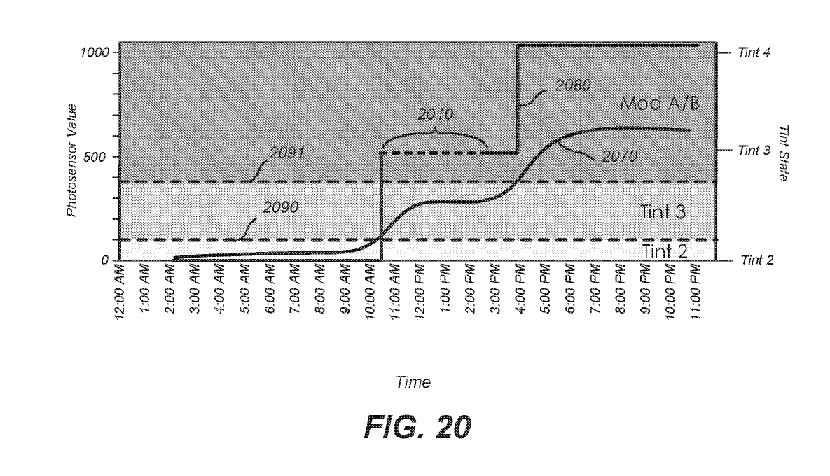

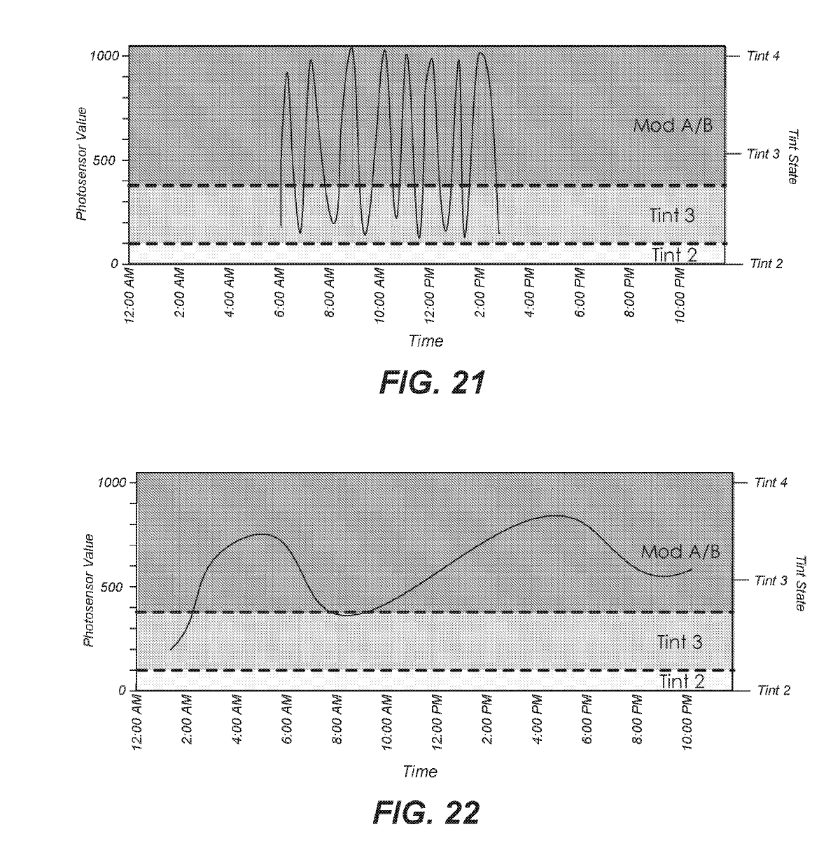

The control methods described herein make tinting decisions based on statistically assessments of macro-oscillations in the photosensor readings and other input data. In one embodiment, tint decisions based by the control method may also take into account micro-oscillations such as by including box cars. FIG. 21 shows a graph of micro-oscillations (top of page) a FIG. 22 shows a graph of macro-oscillations (bottom) for comparison.

V. Building Management Systems (BMSs)

The window controllers described herein also are suited for integration with a BMS. A BMS is a computer-based control system installed in a building that monitors and controls the building's mechanical and electrical equipment such as ventilation, lighting, power systems, elevators, fire systems, and security systems. A BMS consists of hardware, including interconnections by communication channels to a computer or computers, and associated software for maintaining conditions in the building according to preferences set by the occupants and/or by the building manager. For example, a BMS may be implemented using a local area network, such as Ethernet. The software can be based on, for example, internet protocols and/or open standards. One example is software from Tridium, Inc. (of Richmond, Va.). One communications protocol commonly used with a BMS is BACnet (building automation and control networks).

A BMS is most common in a large building, and typically functions at least to control the environment within the building. For example, a BMS may control temperature, carbon dioxide levels, and humidity within a building. Typically, there are many mechanical devices that are controlled by a BMS such as heaters, air conditioners, blowers, vents, and the like. To control the building environment, a BMS may turn on and off these various devices under defined conditions. A core function of a typical modern BMS is to maintain a comfortable environment for the building's occupants while minimizing heating and cooling costs/demand. Thus, a modern BMS is used not only to monitor and control, but also to optimize the synergy between various systems, for example, to conserve energy and lower building operation costs.

In some embodiments, a window controller is integrated with a BMS, where the window controller is configured to control one or more electrochromic windows or other tintable windows. In one embodiment, the one or more electrochromic windows include at least one all solid state and inorganic electrochromic device, but may include more than one electrochromic device, e.g. where each lite or pane of an IGU is tintable. In one embodiment, the one or more electrochromic windows include only all solid state and inorganic electrochromic devices. In one embodiment, the electrochromic windows are multistate electrochromic windows, as described in U.S. patent application Ser. No. 12/851,514, filed on Aug. 5, 2010, and entitled “Multipane Electrochromic Windows.”

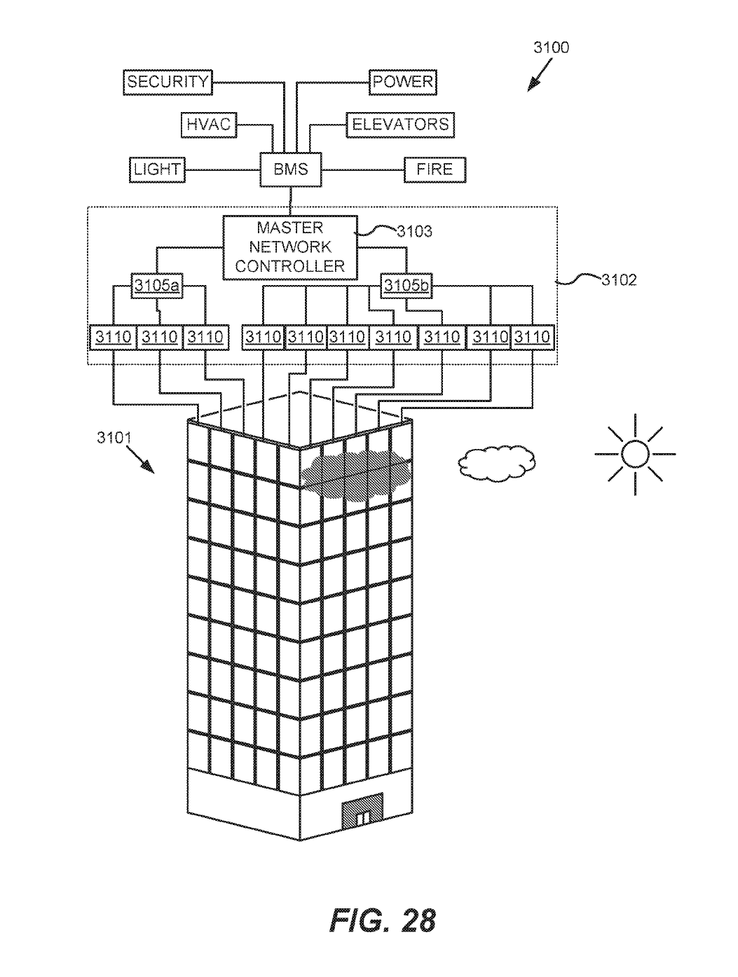

FIG. 28 depicts a schematic diagram of an embodiment of a BMS 3100, that manages a number of systems of a building 3101, including security systems, heating/ventilation/air conditioning (HVAC), lighting of the building, power systems, elevators, fire systems, and the like. Security systems may include magnetic card access, turnstiles, solenoid driven door locks, surveillance cameras, burglar alarms, metal detectors, and the like. Fire systems may include fire alarms and fire suppression systems including a water plumbing control. Lighting systems may include interior lighting, exterior lighting, emergency warning lights, emergency exit signs, and emergency floor egress lighting. Power systems may include the main power, backup power generators, and uninterrupted power source (UPS) grids.

Also, BMS 3100 manages a master window controller 3102. In this example, master window controller 3102 is depicted as a distributed network of window controllers including a master network controller, 3103, intermediate network controllers, 3105a and 3105b, and end or leaf controllers 3110. End or leaf controllers 3110 may be similar to window controller 450 described with respect to FIG. 4. For example, master network controller 3103 may be in proximity to the BMS 3100, and each floor of building 3101 may have one or more intermediate network controllers 3105a and 3105b, while each window of the building has its own end controller 3110. In this example, each of controllers 3110 controls a specific electrochromic window of building 3101.

Each of controllers 3110 can be in a separate location from the electrochromic window that it controls, or be integrated into the electrochromic window. For simplicity, only ten electrochromic windows of building 3101 are depicted as controlled by master window controller 3102. In a typical setting there may be a large number of electrochromic windows in a building controlled by master window controller 3102. Master window controller 3102 need not be a distributed network of window controllers. For example, a single end controller which controls the functions of a single electrochromic window also falls within the scope of the embodiments disclosed herein, as described above.

One aspect of the disclosed embodiments is a BMS including a multipurpose electrochromic window controller as described herein. By incorporating feedback from a electrochromic window controller, a BMS can provide, for example, enhanced: 1) environmental control, 2) energy savings, 3) security, 4) flexibility in control options, 5) improved reliability and usable life of other systems due to less reliance thereon and therefore less maintenance thereof, 6) information availability and diagnostics, 7) effective use of, and higher productivity from, staff, and various combinations of these, because the electrochromic windows can be automatically controlled. In some embodiments, a BMS may not be present or a BMS may be present but may not communicate with a master network controller or communicate at a high level with a master network controller. In certain embodiments, maintenance on the BMS would not interrupt control of the electrochromic windows.

In some cases, the systems of BMS 3100 may run according to daily, monthly, quarterly, or yearly schedules. For example, the lighting control system, the window control system, the HVAC, and the security system may operate on a 24 hour schedule accounting for when people are in the building during the work day. At night, the building may enter an energy savings mode, and during the day, the systems may operate in a manner that minimizes the energy consumption of the building while providing for occupant comfort. As another example, the systems may shut down or enter an energy savings mode over a holiday period.

The scheduling information may be combined with geographical information. Geographical information may include the latitude and longitude of the building. Geographical information also may include information about the direction that each side of the building faces. Using such information, different rooms on different sides of the building may be controlled in different manners. For example, for east facing rooms of the building in the winter, the window controller may instruct the windows to have no tint in the morning so that the room warms up due to sunlight shining in the room and the lighting control panel may instruct the lights to be dim because of the lighting from the sunlight. The west facing windows may be controllable by the occupants of the room in the morning because the tint of the windows on the west side may have no impact on energy savings. However, the modes of operation of the east facing windows and the west facing windows may switch in the evening (e.g., when the sun is setting, the west facing windows are not tinted to allow sunlight in for both heat and lighting).

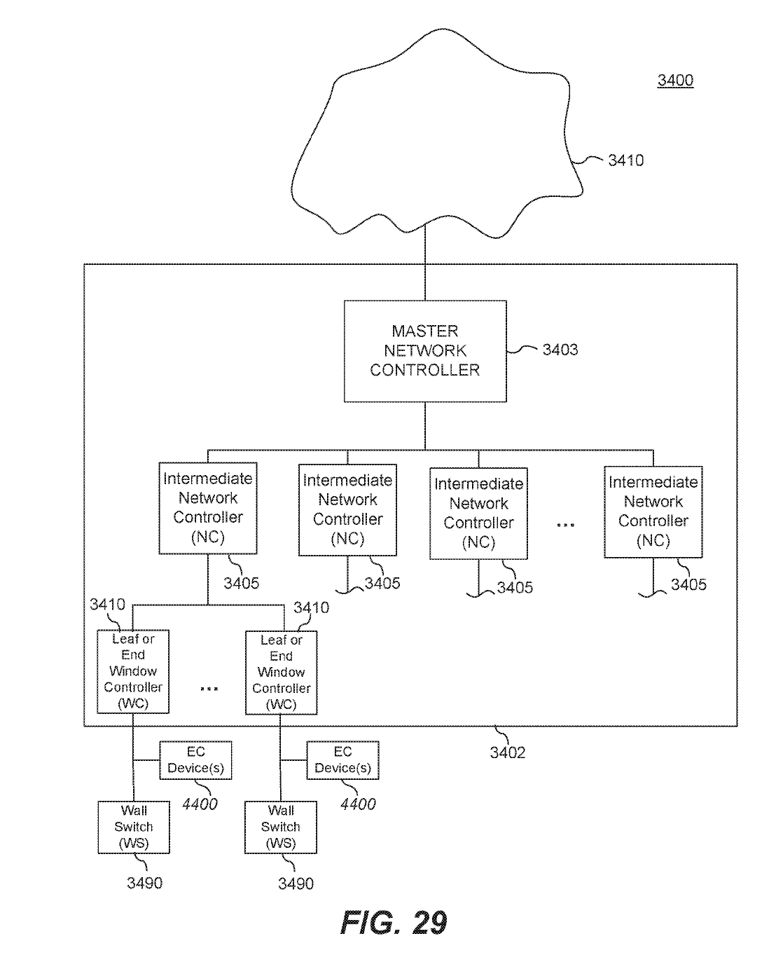

Described below is an example of a building, for example, like building 3101 in FIG. 29, including a building network or a BMS, tintable windows for the exterior windows of the building (i.e., windows separating the interior of the building from the exterior of the building), and a number of different sensors. Light from exterior windows of a building generally has an effect on the interior lighting in the building about 20 feet or about 30 feet from the windows. That is, space in a building that is more that about 20 feet or about 30 feet from an exterior window receives little light from the exterior window. Such spaces away from exterior windows in a building are lit by lighting systems of the building.

Further, the temperature within a building may be influenced by exterior light and/or the exterior temperature. For example, on a cold day and with the building being heated by a heating system, rooms closer to doors and/or windows will lose heat faster than the interior regions of the building and be cooler compared to the interior regions.

For exterior sensors, the building may include exterior sensors on the roof of the building. Alternatively, the building may include an exterior sensor associated with each exterior window or an exterior sensor on each side of the building. An exterior sensor on each side of the building could track the irradiance on a side of the building as the sun changes position throughout the day.

Regarding the methods described with respect to FIG. 7 and other examples, when a window controller is integrated into a building network or a BMS, outputs from exterior sensors may be input to a network of BMS and provided as input to the local window controller. For example, in some embodiments, output signals from any two or more sensors are received. In some embodiments, only one output signal is received, and in some other embodiments, three, four, five, or more outputs are received. These output signals may be received over a building network or a BMS.

In some embodiments, the output signals received include a signal indicating energy or power consumption by a heating system, a cooling system, and/or lighting within the building. For example, the energy or power consumption of the heating system, the cooling system, and/or the lighting of the building may be monitored to provide the signal indicating energy or power consumption. Devices may be interfaced with or attached to the circuits and/or wiring of the building to enable this monitoring. Alternatively, the power systems in the building may be installed such that the power consumed by the heating system, a cooling system, and/or lighting for an individual room within the building or a group of rooms within the building can be monitored.

Tint instructions can be provided to change to tint of the tintable window to the determined level of tint. For example, referring to FIG. 29, this may include master network controller 3103 issuing commands to one or more intermediate network controllers 3105a and 3105b, which in turn issue commands to end controllers 3110 that control each window of the building. End controllers 3100 may apply voltage and/or current to the window to drive the change in tint pursuant to the instructions.

In some embodiments, a building including electrochromic windows and a BMS may be enrolled in or participate in a demand response program run by the utility or utilities providing power to the building. The program may be a program in which the energy consumption of the building is reduced when a peak load occurrence is expected. The utility may send out a warning signal prior to an expected peak load occurrence. For example, the warning may be sent on the day before, the morning of, or about one hour before the expected peak load occurrence. A peak load occurrence may be expected to occur on a hot summer day when cooling systems/air conditioners are drawing a large amount of power from the utility, for example. The warning signal may be received by the BMS of the building or by window controllers configured to control the electrochromic windows in the building. This warning signal can be an override mechanism that disengages the Modules A, B, and C. The BMS can then instruct the window controller(s) to transition the appropriate electrochromic device in the electrochromic windows 505 to a dark tint level aid in reducing the power draw of the cooling systems in the building at the time when the peak load is expected.

In some embodiments, tintable windows for the exterior windows of the building (i.e., windows separating the interior of the building from the exterior of the building), may be grouped into zones, with tintable windows in a zone being instructed in a similar manner. For example, groups of electrochromic windows on different floors of the building or different sides of the building may be in different zones. For example, on the first floor of the building, all of the east facing electrochromic windows may be in zone 1, all of the south facing electrochromic windows may be in zone 2, all of the west facing electrochromic windows may be in zone 3, and all of the north facing electrochromic windows may be in zone 4. As another example, all of the electrochromic windows on the first floor of the building may be in zone 1, all of the electrochromic windows on the second floor may be in zone 2, and all of the electrochromic windows on the third floor may be in zone 3. As yet another example, all of the east facing electrochromic windows may be in zone 1, all of the south facing electrochromic windows may be in zone 2, all of the west facing electrochromic windows may be in zone 3, and all of the north facing electrochromic windows may be in zone 4. As yet another example, east facing electrochromic windows on one floor could be divided into different zones. Any number of tintable windows on the same side and/or different sides and/or different floors of the building may be assigned to a zone. In embodiments where individual tintable windows have independently controllable zones, tinting zones may be created on a building façade using combinations of zones of individual windows, e.g. where individual windows may or may not have all of their zones tinted.

In some embodiments, electrochromic windows in a zone may be controlled by the same window controller. In some other embodiments, electrochromic windows in a zone may be controlled by different window controllers, but the window controllers may all receive the same output signals from sensors and use the same function or lookup table to determine the level of tint for the windows in a zone.

In some embodiments, electrochromic windows in a zone may be controlled by a window controller or controllers that receive an output signal from a transmissivity sensor. In some embodiments, the transmissivity sensor may be mounted proximate the windows in a zone. For example, the transmissivity sensor may be mounted in or on a frame containing an IGU (e.g., mounted in or on a mullion, the horizontal sash of a frame) included in the zone. In some other embodiments, electrochromic windows in a zone that includes the windows on a single side of the building may be controlled by a window controller or controllers that receive an output signal from a transmissivity sensor.

In some embodiments, a sensor (e.g., photosensor) may provide an output signal to a window controller to control the electrochromic windows of a first zone (e.g., a master control zone). The window controller may also control the electrochromic windows in a second zone (e.g., a slave control zone) in the same manner as the first zone. In some other embodiments, another window controller may control the electrochromic windows in the second zone in the same manner as the first zone.

In some embodiments, a building manager, occupants of rooms in the second zone, or other person may manually instruct (using a tint or clear command or a command from a user console of a BMS, for example) the electrochromic windows in the second zone (i.e., the slave control zone) to enter a tint level such as a colored state (level) or a clear state. In some embodiments, when the tint level of the windows in the second zone is overridden with such a manual command, the electrochromic windows in the first zone (i.e., the master control zone) remain under control of the window controller receiving output from the transmissivity sensor. The second zone may remain in a manual command mode for a period of time and then revert back to be under control of the window controller receiving output from the transmissivity sensor. For example, the second zone may stay in a manual mode for one hour after receiving an override command, and then may revert back to be under control of the window controller receiving output from the transmissivity sensor.

In some embodiments, a building manager, occupants of rooms in the first zone, or other person may manually instruct (using a tint command or a command from a user console of a BMS, for example) the windows in the first zone (i.e., the master control zone) to enter a tint level such as a colored state or a clear state. In some embodiments, when the tint level of the windows in the first zone is overridden with such a manual command, the electrochromic windows in the second zone (i.e., the slave control zone) remain under control of the window controller receiving outputs from the exterior sensor. The first zone may remain in a manual command mode for a period of time and then revert back to be under control of window controller receiving output from the transmissivity sensor. For example, the first zone may stay in a manual mode for one hour after receiving an override command, and then may revert back to be under control of the window controller receiving output from the transmissivity sensor. In some other embodiments, the electrochromic windows in the second zone may remain in the tint level that they are in when the manual override for the first zone is received. The first zone may remain in a manual command mode for a period of time and then both the first zone and the second zone may revert back to be under control of the window controller receiving output from the transmissivity sensor.

Any of the methods described herein of control of a tintable window, regardless of whether the window controller is a standalone window controller or is interfaced with a building network, may be used control the tint of a tintable window.

Wireless or Wired Communication

In some embodiments, window controllers described herein include components for wired or wireless communication between the window controller, sensors, and separate communication nodes. Wireless or wired communications may be accomplished with a communication interface that interfaces directly with the window controller. Such interface could be native to the microprocessor or provided via additional circuitry enabling these functions.

A separate communication node for wireless communications can be, for example, another wireless window controller, an end, intermediate, or master window controller, a remote control device, or a BMS. Wireless communication is used in the window controller for at least one of the following operations: programming and/or operating the electrochromic window e.g., window 505 in FIG. 5, collecting data from the electrochromic window from the various sensors and protocols described herein, and using the electrochromic window as a relay point for wireless communication. Data collected from electrochromic windows also may include count data such as number of times an electrochromic device has been activated, efficiency of the electrochromic device over time, and the like. These wireless communication features is described in more detail below.

In one embodiment, wireless communication is used to operate the associated electrochromic windows, for example, via an infrared (IR), and/or radio frequency (RF) signal. In certain embodiments, the controller will include a wireless protocol chip, such as Bluetooth, EnOcean, WiFi, Zigbee, and the like. Window controllers may also have wireless communication via a network. Input to the window controller can be manually input by an end user at a wall switch, either directly or via wireless communication, or the input can be from a BMS of a building of which the electrochromic window is a component.

In one embodiment, when the window controller is part of a distributed network of controllers, wireless communication is used to transfer data to and from each of a plurality of electrochromic windows via the distributed network of controllers, each having wireless communication components. For example, referring again to FIG. 29, master network controller 3103, communicates wirelessly with each of intermediate network controllers 3105a and 3105b, which in turn communicate wirelessly with end controllers 3110, each associated with an electrochromic window. Master network controller 3103 may also communicate wirelessly with the BMS 3100. In one embodiment, at least one level of communication in the window controller is performed wirelessly.

In some embodiments, more than one mode of wireless communication is used in the window controller distributed network. For example, a master window controller may communicate wirelessly to intermediate controllers via WiFi or Zigbee, while the intermediate controllers communicate with end controllers via Bluetooth, Zigbee, EnOcean, or other protocol. In another example, window controllers have redundant wireless communication systems for flexibility in end user choices for wireless communication.

Wireless communication between, for example, master and/or intermediate window controllers and end window controllers offers the advantage of obviating the installation of hard communication lines. This is also true for wireless communication between window controllers and BMS. In one aspect, wireless communication in these roles is useful for data transfer to and from electrochromic windows for operating the window and providing data to, for example, a BMS for optimizing the environment and energy savings in a building. Window location data as well as feedback from sensors are synergized for such optimization. For example, granular level (window-by-window) microclimate information is fed to a BMS in order to optimize the building's various environments.

VI. Example of System for Controlling Functions of Tintable Windows

FIG. 29 is a block diagram of components of a system 3400 for controlling functions (e.g., transitioning to different tint levels) of one or more tintable windows of a building (e.g., building 3101 shown in FIG. 28), according to embodiments. System 3400 may be one of the systems managed by a BMS (e.g., BMS 3100 shown in FIG. 28) or may operate independently of a BMS.

System 3400 includes a master window controller 3402 that can send control signals to the tintable windows to control its functions. System 3400 also includes a network 3410 in electronic communication with master window controller 3402. The control logic, other control logic and instructions for controlling functions of the tintable window(s), and/or sensor data may be communicated to the master window controller 3402 through the network 3410. Network 3410 can be a wired or wireless network (e.g. cloud network). In one embodiment, network 3410 may be in communication with a BMS to allow the BMS to send instructions for controlling the tintable window(s) through network 3410 to the tintable window(s) in a building.

System 3400 also includes electrochromic devices 4400 of the tintable windows (not shown) and wall switches 4490, which are both in electronic communication with master window controller 3402. In this illustrated example, master window controller 1402 can send control signals to electrochromic device(s) 4400 to control the tint level of the tintable windows having the electrochromic device(s) 4400. Each wall switch 3490 is also in communication with electrochromic device(s) 4400 and master window controller 3402. An end user (e.g., occupant of a room having the tintable window) can use the wall switch 3490 to control the tint level and other functions of the tintable window having the electrochromic device(s) 4400.

In FIG. 29, master window controller 3402 is depicted as a distributed network of window controllers including a master network controller 3403, a plurality of intermediate network controllers 3405 in communication with the master network controller 3403, and multiple pluralities of end or leaf window controllers 3410. Each plurality of end or leaf window controllers 3410 is in communication with a single intermediate network controller 3405. Although master window controller 3402 is illustrated as a distributed network of window controllers, master window controller 3402 could also be a single window controller controlling the functions of a single tintable window in other embodiments. The components of the system 1400 in FIG. 29 may be similar in some respects to components described with respect to FIG. 28. For example, master network controller 3403 may be similar to master network controller 3103 and intermediate network controllers 3405 may be similar to intermediate network controllers 3105. Each of the window controllers in the distributed network of FIG. 29 may include a processor (e.g., microprocessor) and a computer readable medium in electrical communication with the processor.

In FIG. 29, each leaf or end window controller 3410 is in communication with EC device(s) 4400 of a single tintable window to control the tint level of that tintable window in the building. In the case of an IGU, the leaf or end window controller 3410 may be in communication with EC devices 4400 on multiple lites of the IGU control the tint level of the IGU. In other embodiments, each leaf or end window controller 3410 may be in communication with a plurality of tintable windows. The leaf or end window controller 3410 may be integrated into the tintable window or may be separate from the tintable window that it controls. Leaf and end window controllers 3410 in FIG. 29 may be similar to the end or leaf controllers 3110 in FIG. 28 and/or may also be similar to window controller 450 described with respect to FIG. 4.

Each wall switch 3490 can be operated by an end user (e.g., occupant of the room) to control the tint level and other functions of the tintable window in communication with the wall switch 3490. The end user can operate the wall switch 3490 to communicate control signals to the EC devices 4400 in the associated tintable window. These signals from the wall switch 3490 may override signals from master window controller 3402 in some cases. In other cases (e.g., high demand cases), control signals from the master window controller 3402 may override the control signals from wall switch 3490. Each wall switch 3490 is also in communication with the leaf or end window controller 3410 to send information about the control signals (e.g. time, date, tint level requested, etc.) sent from wall switch 3490 back to master window controller 3402. In some cases, wall switches 3490 may be manually operated. In other cases, wall switches 3490 may be wirelessly controlled by the end user using a remote device (e.g., cell phone, tablet, etc.) sending wireless communications with the control signals, for example, using infrared (IR), and/or radio frequency (RF) signals. In some cases, wall switches 3490 may include a wireless protocol chip, such as Bluetooth, EnOcean, WiFi, Zigbee, and the like. Although wall switches 3490 depicted in FIG. 29 are located on the wall(s), other embodiments of system 3400 may have switches located elsewhere in the room.

Modifications, additions, or omissions may be made to any of the above-described control logic, other control logic and their associated control methods (e.g., logic described with respect to FIG. 7) without departing from the scope of the disclosure. Any of the logic described above may include more, fewer, or other logic components without departing from the scope of the disclosure. Additionally, the steps of the described logic may be performed in any suitable order without departing from the scope of the disclosure.

Also, modifications, additions, or omissions may be made to the above-described systems or components of a system without departing from the scope of the disclosure. The components of the may be integrated or separated according to particular needs. For example, the master network controller and intermediate network controller may be integrated into a single window controller. Moreover, the operations of the systems can be performed by more, fewer, or other components. Additionally, operations of the systems may be performed using any suitable logic comprising software, hardware, other logic, or any suitable combination of the preceding.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Python using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

Although the foregoing disclosed embodiments have been described in some detail to facilitate understanding, the described embodiments are to be considered illustrative and not limiting. It will be apparent to one of ordinary skill in the art that certain changes and modifications can be practiced within the scope of the appended claims.

One or more features from any embodiment may be combined with one or more features of any other embodiment without departing from the scope of the disclosure. Further, modifications, additions, or omissions may be made to any embodiment without departing from the scope of the disclosure. The components of any embodiment may be integrated or separated according to particular needs without departing from the scope of the disclosure.

What is claimed is:

1. A method of controlling tint of a tintable window in a building, the method comprising:
defining one or more threshold values of environmental conditions across a defined time period;
defining two or more discrete tint state values for the tintable window;
receiving input readings of actual conditions outside the building; and
if the input readings during the defined time period cross one or two of the one or more threshold values, sending a tint command to transition the tintable window from a first tint state toward a second tint state and not transitioning further during a lockout period.

2. The method of claim 1, wherein the input readings comprise one or more of visible light photosensor readings, infrared sensor readings, and weather feed data.

3. The method of claim 1, wherein one of the one or more threshold values is defined if the defined time period is in a tail regime and wherein two of the one or more threshold values are defined if the defined time period is in a daytime regime.

4. The method of claim 1, wherein the one or more threshold values are defined based on whether the defined time period is in a tail regime between sunrise and a first offset after sunrise or in a daytime regime between sunset and a second offset before sunset.

5. The method of claim 1, further comprising determining whether the defined time period is in a tail regime by evaluating one or more of smoothness, oscillating frequency, and slope of a curve of the input readings over the defined time period, wherein the one or more threshold values are defined based on whether the defined time period is in the tail regime.

6. The method of claim 6, further comprising:
determining the second tint state using a module A algorithm and/or a module B algorithm if at least one of the input readings during the defined time period is above the uppermost of the one or more threshold values; and
determining the second tint state using a module C algorithm if at least one of the input readings during the defined time period is below the uppermost of the one or more threshold values.

7. The method of claim 6,
wherein the module A algorithm determines the second tint state by calculating a penetration depth of sunlight through the tintable window and determining the second tint state based on the calculated penetration depth and space type of a room having the tintable window;
wherein the module B algorithm determines the second tint state based on a calculated solar irradiance flowing through the tintable window under clear sky conditions; and
wherein the module C algorithm determines the second tint state based on the actual conditions outside the building.

8. The method of claim 1, further comprising:
monitoring the one or more input readings during the lockout period; and
assessing a probable outside condition based on the input readings monitored during the lockout period; and
determining a third tint state applied after the lockout period based on the probable outside condition.

9. The method of claim 1, further comprising:
monitoring the one or more input readings during the lockout period; and
statistically assessing a third tint state applied after the lockout period based on tint states determined during the lockout period by one or more logic algorithms.

10. The method of claim 1, further comprising:
receiving an override tint state; and
sending an override tint command to transition the tintable window to the override tint state.

11. The method of claim 10, wherein the override tint state is received from a wall switch or a mobile device.

12. A controller for controlling tint of a tintable window in a building, the controller comprising:
a pulse width modulator in communication with the tintable window and configured to send a signal with tint instructions to transition tint of the tintable window when a tint command is received; and
a processor in communication with the pulse width modulator and configured to:
define one or more threshold values of environmental conditions across a defined time period;
define two or more discrete tint state values for the tintable window;
receive input readings of actual conditions outside the building; and
if the input readings during the defined time period cross one or two threshold values, send the signal with tint instructions to the pulse width modulator to transition the tintable window from a first tint state toward a second tint state and not transition further during a lockout period.

13. The controller of claim 12, wherein the input readings comprise one or more of a visible light photosensor readings, infrared sensor readings, and weather feed data.

14. The controller of claim 12, wherein one threshold value is defined if the defined time period is in a tail regime and wherein two threshold values are defined if the defined time period is in a daytime regime.

15. The controller of claim 12, wherein the one or more threshold values are defined based on whether the defined time period is in a tail regime between sunrise and a first offset after sunrise or in a daytime regime between sunset and a second offset before sunset.

16. The controller of claim 12, wherein the processor is further configured to determine whether the defined time period is in a tail regime by evaluating one or more of smoothness, oscillating frequency, or slope of a curve of the input readings over the defined time period, wherein the one or more threshold values are defined based on whether the defined time period is in the tail regime.

17. The controller of claim 12, wherein the processor is further configured to:
determine the second tint state using a module A algorithm and/or a module B algorithm if at least one of the input readings during the defined time period is above the uppermost of the one or more threshold values; and
determine the second tint state using a module C algorithm if at least one of the input readings during the defined time period is below the uppermost of the one or more threshold values.

18. The controller of claim 17,
wherein the module A algorithm is configured to determine the second tint state by calculating a penetration depth of sunlight through the tintable window and determining the second tint state based on the calculated penetration depth and space type of a room having the tintable window;
wherein the module B algorithm is configured to determine the second tint state based on a calculated solar irradiance flowing through the tintable window under clear sky conditions; and
wherein the module C algorithm is configured to determine the second tint state based on the actual conditions outside the building.

19. The controller of claim 12, wherein the processor is further configured to determine the second tint state using one or more logic algorithms.

20. The controller of claim 12, wherein the processor is further configured to:
monitor the one or more input readings during the lockout period; and
assess a probable outside condition based on the input readings monitored during the lockout period; and
determine a third tint state applied after the lockout period based on the probable outside condition.

21. The controller of claim 12, wherein the processor is further configured to
monitor the one or more input readings during the lockout period; and
statistically assess a third tint state applied after the lockout period based on tint states determined during the lockout period by one or more logic algorithms.

22. The controller of claim 12, wherein the processor is further configured to
receive an override tint state; and
send an override tint command to transition the tintable window to the override tint state.

23. The controller of claim 12, wherein the override tint level is received from a wall switch or a mobile device.
